(19) United States
(12) Patent Application Publication
(10) Pub. No.: US 2025/0355234 A1
(43) Pub. Date: Nov. 20, 2025

(54) SAMPLE SLIDE PREPARATION SYSTEM WITH CALIBRATION AND POSITION SENSING FOR MEASUREMENT CONSISTENCY

(71) Applicants: Radoratory Technologies Pvt Ltd., Hyderabad (IN); Radoratory Technologies, Inc., Wilmington, DE (US)

(72) Inventors: Junaid SHAIK, Tirupati (IN); Faisal Ahmed SHEIKH, Indore (IN)

(73) Assignees: Radoratory Technologies Pvt Ltd., Hyderabad (IN); Radoratory Technologies, Inc., Wilmington, DE (US)

(21) Appl. No.: 19/283,803

(22) Filed: Jul. 29, 2025

Related U.S. Application Data
(63) Continuation of application No. PCT/US2024/013610, filed on Jan. 30, 2024.

(30) Foreign Application Priority Data
Jan. 30, 2023 (IN) 202321005977
Jan. 30, 2023 (IN) 202321005980

(51) Int. Cl. G02B 21/34; G01N 35/00

(52) U.S. Cl. CPC G02B 21/34; G01N 35/00693; G01N 2035/00138; G01N 2035/00306

(57) ABSTRACT

An apparatus for preparing slides with samples for acquisition of measurement data by an analytical instrument can include one or more structures configured to receive one or more slides, a blade assembly including one or more blades configured to distribute one or more samples onto the one or more slides for subsequent measurement and/or diagnostic analysis, and a motor mechanically coupled to the blade assembly and disposed within a housing. The motor is configured to cause the blade assembly to move from a first position to a second position and to return from the second position to the first position in response to actuation. Each blade of the one or more blades is configured to distribute a corresponding sample for measurement and/or analysis onto a corresponding slide as the blade assembly moves from the second position to the first position.

### CROSS-REFERENCE TO RELATED APPLICATIONS

The present application is a continuation under 35 U.S.C. § 111(a) of International Application No. PCT/US2024/013610, filed on Jan. 30, 2024, which claims priority to Indian Provisional Patent Application No. 202321005977, filed on Jan. 30, 2023, and Indian Provisional Patent Application No. 202321005980 filed on Jan. 30, 2023, the entire disclosures of the foregoing applications are incorporated herein by reference.

### FIELD OF DISCLOSURE

The present disclosure relates generally to preparation of pathological samples, such as blood samples, on slides for measurement and/or analysis by a microscope or other diagnostic instrumentation.

### BACKGROUND

The present disclosure relates to systems, devices, and methods for automated preparation of samples on slides for subsequent measurement and/or analysis, such as microscopic examination and quantitative diagnostic testing. The present disclosure further relates to an eccentric screw that can be used in automated slide preparation systems and/or related measuring apparatus for precise adjustment of component positions. In addition, the present disclosure relates to a flange-based position tracking sensor configured to provide accurate position data of a moving element, supporting reliable and repeatable preparation of samples for measurement and/or evaluation.

### SUMMARY

In some aspects, the techniques described herein relate to an apparatus for preparing slides with samples for acquisition of measurement data by at least one analytical instrument, including: one or more structures configured to receive one or more slides; a blade assembly including one or more blades configured to prepare for measurement one or more samples on the one or more slides; and a motor mechanically coupled to the blade assembly and disposed within a housing, the motor configured to cause the blade assembly to move from a first position to a second position and return from the second position to the first position responsive to actuating the motor, each blade of the one or more blades is configured to prepare for measurement a corresponding sample of the one or more samples placed on a corresponding slide responsive to the blade assembly moving from the second position to the first position.

In some aspects, the techniques described herein relate to an apparatus, further including a motor actuator including at least one of a push button, a switch or a touch screen and wherein the motor actuator is disposed on an external surface of the housing.

In some aspects, the techniques described herein relate to an apparatus, wherein in response to the push button being pressed, the motor is actuated to rotate in a first direction causing the blade assembly to move from the first position to the second position, and responsive to the push button being released, the motor is actuated to rotate in a second direction opposite to the first direction causing the blade assembly to move from the second position to the first position.

In some aspects, the techniques described herein relate to an apparatus, wherein the motor, responsive to actuating the motor actuator, rotates in a first direction to cause the blade assembly to move from the first position to the second position, and wherein the blade assembly, responsive to deactivating the motor actuator, moves from the second position to the first position.

In some aspects, the techniques described herein relate to an apparatus, wherein the motor, in response to being actuated, causes the blade assembly to (i) move from the first position to the second position, (ii) pause at the second position for a waiting period, and (iii) return from the second position to the first position after the waiting period.

In some aspects, the techniques described herein relate to an apparatus, including an interface, wherein the waiting period is selectable via an input parameter provided via the interface.

In some aspects, the techniques described herein relate to an apparatus, including an arm assembly mechanically coupling the motor to the blade assembly and configured to transfer motion from the motor to the blade assembly.

In some aspects, the techniques described herein relate to an apparatus, including an eccentric screw positioned to restrict motion of the arm assembly at a corresponding arm position that corresponds to the second position of the blade assembly, the eccentric screw including a first screw including a screw head and a shaft arranged at an offset relative to an axis of the screw head, the screw head defining an opening sized to receive a second screw.

In some aspects, the techniques described herein relate to an apparatus, wherein an orientation of the eccentric screw is adjustable to calibrate the second position of the blade assembly.

In some aspects, the techniques described herein relate to an apparatus, wherein the housing includes an opening aligned with the eccentric screw, the opening capable of receiving a screwdriver to adjust the orientation of the eccentric screw.

In some aspects, the techniques described herein relate to an apparatus, further including an eccentric screw positioned to restrict motion of the arm assembly at a corresponding arm position that corresponds to the first position of the blade assembly.

In some aspects, the techniques described herein relate to an apparatus, further including a first sensor configured to detect presence of the blade assembly at the first position and cause a controller to deactivate the motor responsive to receiving a first signal from the first sensor indicative of the presence of the blade assembly at the first position.

In some aspects, the techniques described herein relate to an apparatus, further including a second sensor configured to detect the presence of the blade assembly at the second position and cause the controller to deactivate the motor responsive to receiving a second signal from the second sensor indicative of the presence of the blade assembly at the second position, wherein the controller is further configured to activate the motor to cause the blade assembly to move from the second position to the first position in response to at least one of deactivating a motor actuator or an expiration of a waiting period.

In some aspects, the techniques described herein relate to a method for preparing slides with samples for acquisition of measurement data by at least one analytical instrument, including: receiving one or more slides at one or more structures; actuating a motor mechanically coupled to a blade assembly and disposed within a housing, the blade assembly including one or more blades configured to prepare for measurement one or more samples on one or more slides; and causing, responsive to actuating the motor, the blade assembly to move from a first position to a second position and return from the second position to the first position, each blade of the one or more blades is configured to prepare for measurement a corresponding sample of the one or more samples placed on a corresponding slide of the one or more slides responsive to the blade assembly moving from the second position to the first position.

In some aspects, the techniques described herein relate to a method, including causing the blade assembly to pause at the second position for a waiting period before returning from the second position to the first position.

In some aspects, the techniques described herein relate to a method, including determining the waiting period according to at least one of: an input parameter specifying the waiting period; or an amount of time during which a motor actuator of the motor is actuated.

In some aspects, the techniques described herein relate to a method, including: detecting, by a first sensor, presence of the blade assembly at the first position; and deactivating, by a controller, the motor responsive to receiving a first signal from the first sensor indicative of the presence of the blade assembly at the first position.

In some aspects, the techniques described herein relate to a method, including: detecting, by a second sensor, the presence of the blade assembly at the second position; and deactivating, by the controller, the motor responsive to receiving a second signal from the second sensor indicative of the presence of the blade assembly at the second position.

In some aspects, the techniques described herein relate to a method, wherein the motor is mechanically coupled to the blade assembly via an arm assembly, the method including: restricting, by an eccentric screw, motion of the arm assembly at an arm position that corresponds to the second position of the blade assembly, the eccentric screw including a first screw including a screw head and a shaft arranged at an offset relative to an axis of the screw head, the screw head defining an opening sized to receive a second screw.

In some aspects, the techniques described herein relate to a method, including adjusting an orientation of the eccentric screw to calibrate the second position.

### BRIEF DESCRIPTION OF THE DRAWINGS

FIGS. 1A and 1B show a schematic view and a transparent view of an automatic smearing apparatus, according to an example embodiment of the current disclosure.

FIGS. 2A-2E depict various internal or transparent views of the automatic smearing apparatus, according to an example embodiment of the current disclosure.

FIGS. 3A-3E depict various views of an arm assembly of the automatic smearing apparatus, according to an example embodiment of the current disclosure.

FIG. 4 is a flowchart illustrating a method of automatically smearing a sample on a slide, in accordance with an embodiment of the current disclosure; and

FIGS. 5A-5F depict various states of the automatic smearing apparatus corresponding to different steps of the method in FIG. 4, according to an example embodiment of the current disclosure.

FIGS. 6A-6C depict various views of an eccentric screw assembly, according to example embodiments of the current disclosure.

FIG. 7 depicts a flange-based sensor assembly for position sensing, according to an example embodiment of the current disclosure.

FIGS. 8A-8C depict various views of a system for monitoring relative positions of two devices, according to an example embodiment of the current disclosure.

FIG. 9 shows a flow chart depicting a method for position sensing, according to an example embodiment of the current disclosure.

### DETAILED DESCRIPTION

Following below are more detailed descriptions of various concepts related to, and implementations of, methods, apparatuses, and systems for automatic staining of slides. The various concepts introduced above and discussed in greater detail below may be implemented in any of numerous ways as the described concepts are not limited to any particular manner of implementation. Specific implementations and applications are provided primarily for illustrative purposes.

While the current disclosure describes the automatic smearing as being performed by a separate portable smearing device, it is to be understood that the methods and mechanisms described herein can be implemented or integrated within a device or system that may perform a combination of slide staining, smearing and/or slide scanning.

Blood sample analysis is important for medical diagnosis and clinical research in relation with many diseases. The blood samples are usually chemically processed and smeared before being examined or analyzed under a microscope. The examination of the samples can be used for the purpose of diagnosing a variety of medical conditions. The validity and reliability of the blood sample examinations depends on the quality of the smear.

Smearing is a process in which one or more drops of a blood sample (or a pathological or biological sample of other type) is spread on a slide to form a blood film thereupon, referred to as a smear. One of the goals of the smearing process is to form a monolayer region that can be examined under the microscope. In a monolayer region, cells or other structures are not overlapping, which allows for reliable examination of the characteristics of various types of cells or structures. When cells are disjoint, the shape, size and structure of each cell (e.g., a cell of a given type) can be reliably examined. In particular, examination of the monolayer region enables cell count (or counting other structures or particles such as blood platelet), identification or detection of various particles and/or detection of cell deformation (or deformation of other structures or particles). Blood sample smears are usually used in blood tests that involve looking at the appearance, number, and shape of red blood cells, white blood cells, blood platelets and/or other structures or particles to determine whether they are normal, or blood tests to detect parasites in the blood. Existing methods of performing blood smearing include dropping blood samples on a glass slide and then manually smearing the drop of blood using a cotton ball or other glass slides.

Manual smearing has various shortcomings. First, manual smearing does not produce consistent smearing quality. The quality of the smears depends on the experience and skill of the technician performing the smear. Also, even for an experienced and skilled technician, there is no guarantee that the smears prepared by that technician will have the same quality. Second, improving the quality of produced smears usually involves training for various technicians. Third, with manual smearing it is difficult to accurately standardize and control the smearing process based on the type or quality of the pathological sample. For example, one challenge is how to adjust the smearing process for relatively thicker blood samples to still guarantee good quality smears. Finally, the manual smearing process is relatively slow leading to testing backlogs in various labs.

The above discussed shortcomings of manual smearing call for automated and more reliable smearing processes and devices. Automated smearing is significantly faster than manual smearing. For example, an automated smearing device can process multiple slides in parallel or simultaneously. Also, the time taken by an automated smearing device to perform a smearing process can be shorter than the time taken by a technician to prepare one slide. Furthermore, reducing human handling of the slides and pathological samples reduces the likelihood of contaminated smears. In addition, automated smearing consistently produces higher quality smears than manual smearing.

Designing and/or building automated smearing processes and automatic smearing devices poses various technical challenges. A first technical challenge is how to accurately position and move a blade to smear a sample on a slide. The blade is expected to drag the sample (e.g., one or more blood drops) across a slide to form a relatively thin smear thereon with a monolayer region. To form a smear with a monolayer region, the blade is expected to be in contact or approximately in contact with (e.g., within one or few micrometers away from) the surface of the slide on which the sample is placed as the blade moves across the slide dragging the sample or a portion thereof.

A second technical challenge is how to cause the blade to move across the slide while in contact or approximately in contact with the surface of the slide hosting the sample without damaging (e.g., scratching) the slide and/or damaging the sample (e.g., damaging cells and/or other particles). Maintaining the physical characteristics of the cells and/or particles in the sample is key to a reliable examination (e.g., morphological evaluation) of the sample. Furthermore, the slide thickness may vary within one slide and/or from among various slides. For instance, the dimension of the thickness of the slide is usually subject to some error within a manufacturing error tolerance. The same is true for the dimensions the blades. The variations in the thickness of the slide(s) and/or the variation in the height (or width) of the blade(s) as well as variations in the dimensions of other components can increase the risk of slide damage and/or sample damage.

Another technical challenge is the adaptability or customization of the smearing process based on the physical characteristics of individual samples. For instance, the viscosity of blood samples may vary from one sample to another. To maintain a high smearing quality for various types or characteristics of samples, the automatic smearing device or system can enable adaptation or customization of the smearing process based on the type or characteristics of the sample.

Embodiments described herein address the above discussed technical problems and enable automatic or semi-automatic smearing processes and devices with relatively high smear quality, e.g., compared to exiting solutions. The smearing processes and devices described herein enable relatively faster and scalable smearing, e.g., compared to exiting solutions.

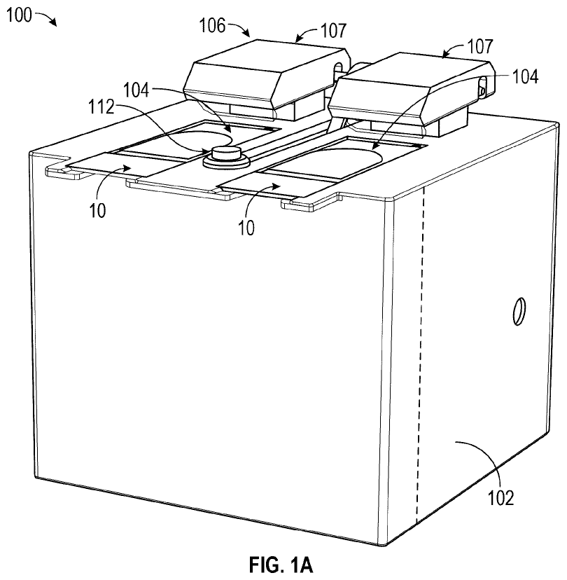

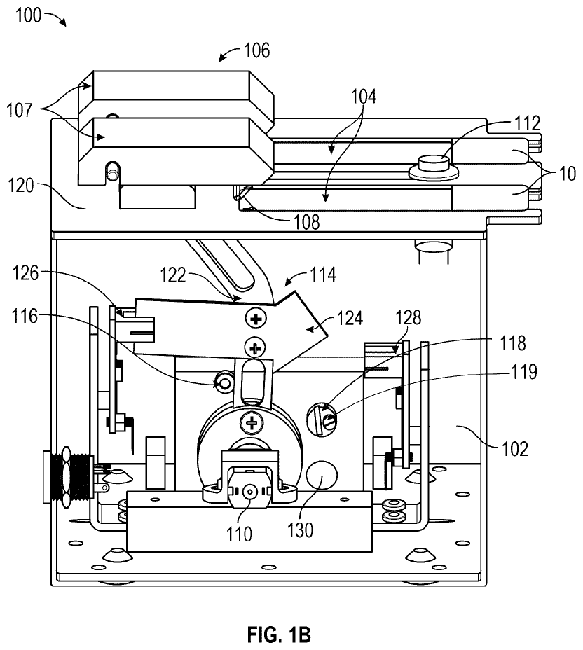

Referring now to FIGS. 1A and 1B, a schematic view and a transparent view of a smearing apparatus 100 are shown, according to an example embodiment of the current disclosure. FIG. 1A shows a schematic view of the smearing apparatus 100 while FIG. 1B shows a transparent view of the smearing apparatus 100. In brief overview, the smearing apparatus 100 can include a housing 102, one or more structures 104 configured to receive one or more slides 10, a blade assembly 106 including one or more spreading blades 108, a motor 110 mechanically coupled to the blade assembly 106 and a motor actuator 112 disposed on the housing 102. The blade assembly can be configured to spread one or more samples on the one or more slides 10. The motor 110 when actuated by the motor actuator 112 can cause the blade assembly 106 to move from a first position to a second position and return from the second position to the first position. Each spreading blade 108 of the one or more spreading blades 108 can be designed, adapted, arranged, structured, or configured to smear a corresponding sample of the one or more samples placed on the corresponding slide 10.

The housing 102 (also referred to herein as housing unit 102) can enclose components of the smearing apparatus 100. For example, and as depicted in FIG. 1A, the motor 110 and the coupling between the motor 110 and the blade assembly 106, among other components, can be enclosed by the housing 102. In some implementations, the structure(s) 104, the blading assembly 106 and/or the motor actuator 112 can be arranged on, set up on and/or secured to the housing 102. The housing 102 can have or include a top surface 120. In some implementations, the structure(s) 104, the blading assembly 106 and/or the motor actuator 112 can be arranged on the top surface 120. The housing 102 can be the main body of the smearing apparatus 100 that can contain the internal mechanisms and can provide structural support.

The smearing apparatus 100 can include one or more structure(s) 104 designed, adapted, arranged, structured, or configured to receive one or more slides. In some implementations, the one or more structures 104 can be or can include one or more recess regions or slide slots arranged on the top surface 120 of the housing 102. For instance, each recess region or slot can be designed, adapted, arranged, structured or configured to receive a single slide 10. The slide 10 can be referred to herein as a microscope slide, microscopic slide or pathology slide. For instance, each recess region can be shaped and/or sized to host a single slide. While the automatic smearing apparatus 100 of FIGS. 1A and 1B are shown to include two recess regions (or two slide slots) hosting two slides 10, in general, the automatic smearing apparatus 100 or the respective top surface 120 can include any number of recess regions to host any number of slides 10.

In some implementations, the structure(s) 104 can include other systems or mechanisms for securing slide(s) 10 at predefined position(s) relative to the blade assembly 106 or the blade(s) 108. For instance, the structure(s) 104 can include one or more gripper devices (or gripper systems) to hold or secure the slide(s) 10 at the predefined positions(s). In some implementations, the structure(s) 104 can include one or more slots or slits for receiving the slide(s) 10. In general, the structure(s) 104 can be designed, adapted, arranged, structured, or configured to secure one or more slide(s) at predefined position(s) relative to the blade assembly 106, such that when the blade assembly 106 is actuated the corresponding spreading blade(s) 108 can spread sample(s) placed on the slide(s) 10.

The blade assembly 106 (also referred to as spreader mount assembly 106) can include one or more spreading blades 108. The blade assembly 106 can be arranged on the top surface 120 of the housing unit 102. The blade assembly 106 can include one or more spreading blade holders 107 (or one or more spreader mount members 107). Each spreading blade holder 107 (or spreader mount member 107) can be designed, adapted, arranged, structured, or configured to hold, carry or secure a corresponding spreading blade 108.

Each spreading blade 108 can be designed, adapted, arranged, structured, or configured to smear a sample (e.g., a blood sample or other biological sample) placed on a corresponding slide 10 located in a corresponding recess region 104. For instance, each spreader holder 107 can be viewed as a sliding structure that is designed, adapted, arranged, structured, or configured to slide or move according to a translational motion above, and/or across a longitudinal dimension of, a corresponding slide 10 and/or a corresponding recess region 104. In some implementations, the spreading blade holders 107 can be mechanically coupled to each other via a rod or shaft as will be discussed in further detail below. As such, the spreading blade holders 107 can be designed, adapted, arranged, structured, or configured to move together in parallel or synchronously. In some implementations, the spreader holders 107 may be mechanically coupled to each other via other mechanical structures and/or mechanisms (e.g., other than a rod or shaft). In some other implementations, the spreader blades 108 may be designed, adapted, arranged, structured, or configured to move independently. In some implementations, the blade assembly 106 can include a single sliding structure or member holding multiple spreading blades 108, such that each spreading blade 108 is positioned, arranged or configured to smear or spread a sample placed on a corresponding slide 10 placed in a corresponding recess region 104.

Each spreading blade 108 can extend outwardly from a corresponding spreading blade holder 107 or from the blade assembly 106. Specifically, the spreading blade 108 can extend toward the corresponding slide 10 or corresponding recess region (or slide slot) 104. Each spreading blade 108 can be oriented or arranged transversally or at an angle with respect to the top surface 120 of the housing 102 or a top surface of the corresponding slide 10. Each spreading blade 108 can be designed, adapted, arranged, structured, or configured to come in contact (or substantially in contact) with the corresponding slide 10 along an edge of the spreading blade 108 when in motion (in smearing mode) or when moving along the corresponding slide 10 to spread or smear a sample on the corresponding slide 10. In particular, the edge of the spreading blade 108 can be in contact or substantially in contact (e.g., within 1 micrometer or within 10 micrometers) with the top surface of the corresponding slide 10 as the blade assembly 106 moves across the slide(s) 10 (e.g., from the first position to the second position and/or from the second position to the first position).

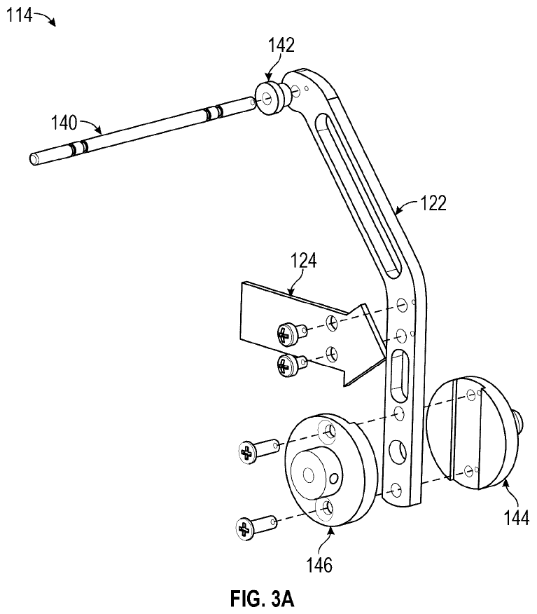

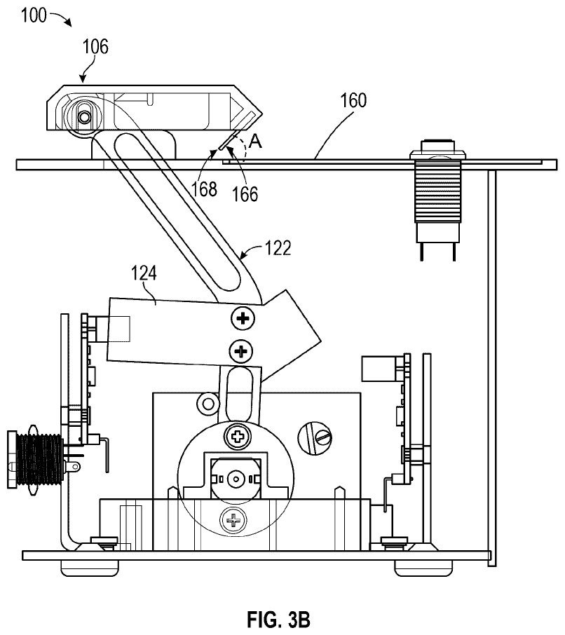

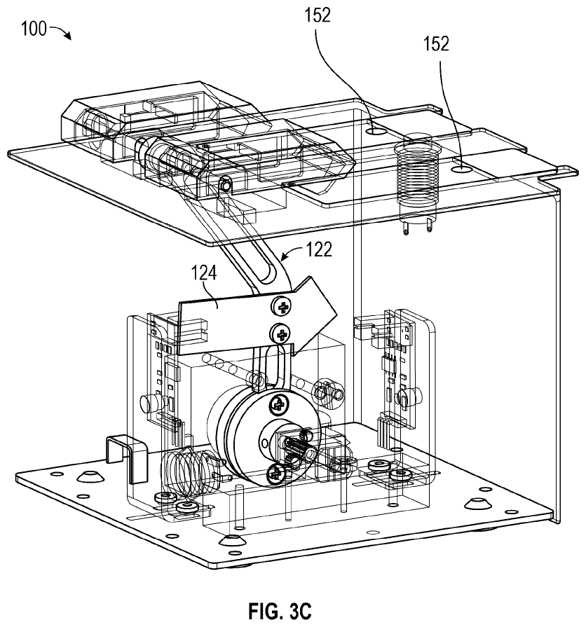

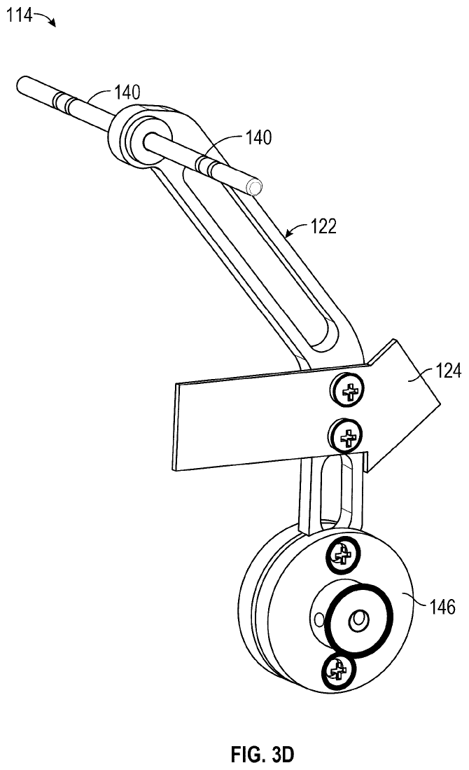

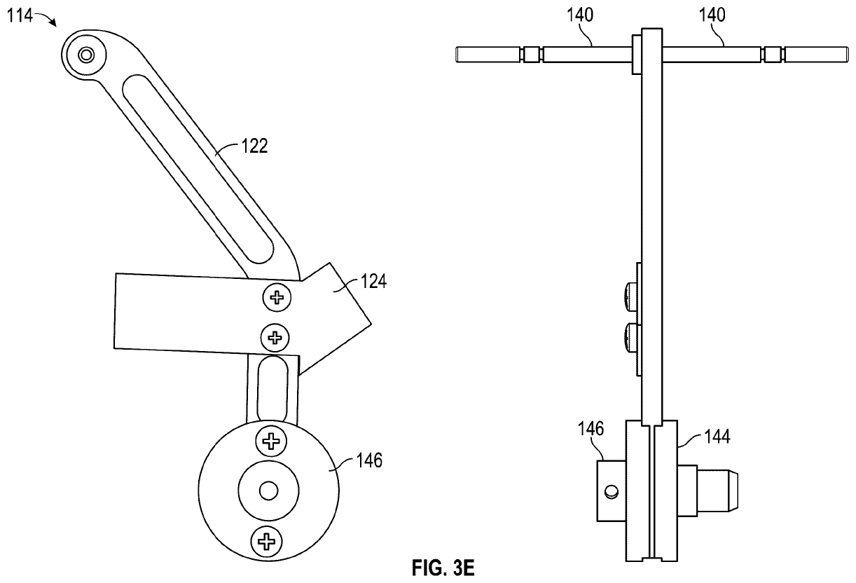

The spreading blade(s) 108 can be referred to herein as spreader(s) 108, spreading structure(s) 108, spreading member(s) 108 and/or spreading slide(s) 108. The spreading blade(s) 108 can be made of glass, a similar material as slide(s) 10 or other material. The spreading blade(s) 108 may have a similar thickness as the slide (s) 10. In some implementations, each spreading blade 108 can be a thin flat piece of glass. In some implementations, the spreading blade(s) 108 can be of glass sheets that are also used to make or manufacture the slide(s) 10. As is described in further detail below in relation with FIG. 3B, the spreading blade(s) 108 can be positioned or oriented at an acute angle, less than 90 degrees, with respect to the top surface 120, the recess region(s) 104 or the slide 10 when the slide 10 is placed in the recess region 104. In other words, the angle between the spreading blade(s) 108 and the surface or region receiving the slide 10 and facing the sample or specimen to be spread can be an acute angle. The angle can be between 20 degrees and 60 degrees, e.g., 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59 or 60. In some implementations, the angle can be between 25 degrees and 53 degrees, e.g., 25, 26, 27, 28, 29, 30, 31, 32, 33, 34, 35, 36, 37, 38, 39, 40, 41, 42, 43, 44, 45, 46, 47, 48, 49, 50, 51, 52, 53.

The automatic smearing apparatus 100 can include a motor 110, such as a servo motor or other type of motor mechanically coupled to the blade assembly 106. In some implementations, the motor 110, when actuated by the motor actuator 112, can cause the blade assembly 106 to move from a first position to a second position and return from the second position to the first position. For example, for each spreading blade 108, the first position can be associated with a first end of the corresponding slide 10 while the second position can be associated with a location where the sample is (expected to be) placed on the slide 10. As the blade assembly 106 moves from the second position back to the first position, each spreading blade 108 can spread or smear a corresponding sample placed on the corresponding slide 10.

In some implementations, the motor 110 when actuated causes the blade assembly 106 to (i) move from the first position to the second position, (ii) pause at the second position for a waiting period, and (iii) return from the second position to the first position after the waiting period. At the second position, each spreading blade 108 can be designed, adapted, arranged, structured, or configured to come in contact (or substantially in contact) with the top surface of the corresponding slide 10 at a location or level where the corresponding sample is placed. For instance, the motion path of the blade assembly 106 can be designed such that when the blade assembly 106 is at the second position, each spreading blade 108 can be in contact with the corresponding sample (e.g., blood sample) placed on the corresponding slide 10. Pausing at the second position for the waiting period allows or enables the sample (e.g., blood sample) to spread along the edge of the spreading blade 108 that is in contact with the sample. Allowing the sample to spread or flow along the edge of the spreading blade 108 leads to relatively wider and thinner smears, which increases the chances of forming a monolayer region.

In some implementations, the waiting period can be adjusted, controlled or defined by an operator of the smearing device 100. The waiting period can be user defined or controlled, set to a default value, or automatically adjusted based on the size and/or dimensions of the sample or specimen present. In some implementations, the waiting period can be executed manually in the case of a button actuator, or digitally in the case of a user interface, touchscreen, etc. In some implementations, the operator of the smearing device 100 can control the waiting period via the motor actuator 112. In some implementations, the smearing device 100 can include an interface (e.g., an input/output (I/O) interface). The operator can define or specify the waiting period as an input parameter provided via the interface. The interface can include graphical user interface (GUI), a communication interface and/or some other type of I/O interface. For example, the smearing device 100 can include a GUI allowing the operator to specify one or more setting parameters, such as the duration of waiting period, of the smearing process. In some implementations, the operator can specify or provide the setting parameter(s) via a remote device and/or a mobile application communicatively coupled to the smearing device 100 via a communication interface.

The concentration of red blood cells can vary from one blood sample to another. A relatively high concentration of red blood cells makes the blood sample thicker and less able or slow to travel or flow. Accordingly, the waiting time period can be selected, defined or caused to be relatively longer for relatively thick blood samples. The waiting time period may be selected, defined or adjusted based on the smearing protocol followed. Different smearing protocols may specify different waiting time periods.

The motor actuator 112 in the automatic smearing apparatus 100 can include a button (e.g., a push button), a switch, a roller, a slider, a touch screen, a user interface to actuate or initiate the operation of the motor 110, to initiate or trigger the smearing process or motion of the blade assembly 106. In some implementations, pushing and releasing the push button (e.g., by a user), can trigger a motion pattern of the spreader holders. For instance, the push button can be communicatively coupled to a processor or controller of the automatic smearing apparatus 100. Pushing, or pushing and releasing, the push button can cause a trigger signal (e.g., an electric signal) to be sent to the processor or the controller. In response to receiving the trigger signal, the processor or the controller can actuate the motor according to a predefined pattern to cause motion, or a sequence of motion, of the spreader holders. For example, pushing and releasing the push button can cause the spreader holders to move across the slides, pause at the other side of the slides (e.g., at the second position) for a waiting period and then move back to the starting position (e.g., the first position). In some implementations, pushing the push button can cause the blade assembly 106 to move across the slides 10 from the first position to the second position and stop at the second position as long as the push button is still being pushed. Releasing the push button can cause the blade assembly 106 to move back to their starting position.

In some implementations, the push button, when pressed, the motor 110 can be actuated to rotate in a first direction causing the blade assembly 106 to move from the first position to the second position, and responsive to the push button being released, the motor 110 can be actuated to rotate in a second direction opposite to the first direction causing the blade assembly 106 to move from the second position to the first position. In some implementations, the motor 110, responsive to actuating the motor actuator 112, rotates in a first direction to cause the blade assembly 106 to move from the first position to the second position, and wherein the blade assembly 106, responsive to deactivating the motor actuator 112, moves from the second position to the first position.

For instance, activating the motor actuator 112, e.g., by pressing the push button, can cause the motor 110 to rotate by a predefined rotation angle, for a predefined number of revolutions, and then stop while the motor actuator 112 is still activated or the push button still pressed. The predefined angle can be defined as the revolution angle causing the blade assembly 106 to move from the first position to the second position. The motor 110 can stay in stationary or still mode while the motor actuator 112 is still activated or the push button still pressed. Deactivating the motor actuator 112, e.g., by releasing the push button, can cause the motor 110 to rotate by the predefined rotation angle in the reverse direction causing the blade assembly 106 to move from the second position to the first position.

In some implementations and as will be described in further detail below, the apparatus 100 can detect, via one or more sensors, the blade assembly 106 arriving (or being present) at the second position while the motor actuator 112 is activated or the push button is pressed. In response to detecting the blade assembly 106 at the second position, a controller or processor of the apparatus 100 can cause the motor to stop rotating. Responsive to deactivating the motor actuator 112, e.g., by releasing the push button, the controller or processor can cause the motor 110 to rotate by the predefined rotation angle in the reverse direction causing the blade assembly 106 to move from the second position to the first position.

In some implementations, the waiting period at the second position can be predefined or provided as input by the user or operator of the apparatus 100. Activating or triggering the motor actuator 112 can cause the motor 110 to (i) rotate by the predefined rotation angle and/or until the blade assembly is detected at the second position, (ii) stop or stay in stationary mode for the waiting time period, and then (iiii) rotate in the opposite direction by the predefined revolution angle or until the blade assembly is detected at the first position. In other words, a single activation or interaction with the motor actuator 112 can cause the blade assembly 106 to move from the first position to the second position, stay at the second position for the waiting period and then move from the second position to the first position.

In some implementations, the motor actuator 112 can include other triggering means such as a switch, a roller, a slider, a touch screen, a user interface, a remote device communicatively coupled to the apparatus 100 and/or a mobile application communicatively coupled to the apparatus 100 to trigger or initiate the smearing process or motion of the blade assembly 106. For example, the user interface can initiate or halt the smearing process, offering precise control over the operation. The digital user interface may allow users to select different smearing protocols or settings tailored for various sample types, desired smear thicknesses. The user interface may provide real-time updates on the status of the smearing process, including progress indicators and alerts if the apparatus encounters any issues. The user interface may display diagnostic information for troubleshooting, such as error messages or maintenance reminders. Users may select, set or adjust parameters via the digital user interface, such as the speed of the blade assembly 106 or the motor 110, the volume of the sample to be spread, the waiting period at the second position and/or the smearing protocol, among others. The user interface may log smearing operations, including user details, sample IDs, and time stamps, which can be crucial for record-keeping and quality control.

The apparatus can include an arm assembly, also referred to herein as spreader arm assembly 114, designed, adapted, arranged, structured, or configured to mechanically couple the motor 110 to the blade assembly 106 (or the spreading blade holder(s) 107). The spreader arm assembly 114 can be designed, adapted, arranged, structured, or configured to mechanically couple the servo motor 110 to the spreader holders 107. The spreader arm assembly 114 can be designed, adapted, arranged, structured, or configured to transform the motor rotational motion into a translational motion of the spreader holders 107. In other words, when the motor 110 is actuated, the motor 110 can cause movement of the spreader arm assembly 114, which in turn causes the blade assembly 106 or the spreader holder(s) 107 to move, e.g., according to a translational motion, from the first position to the second position across the slide(s) 10. When the motor 110 rotates in the reverse direction, the arm spreader assembly 114 can also rotate in the reverse direction causing the blade assembly 106 or the spreader holder(s) 107 to move back from the second position to the first position across the slide(s) 10. In some implementations, the apparatus 100 can include multiple motors 110 (e.g., a separate motor for each spreader holder 107) where the spreader holders 107 can be structured to move independent of each other.

The spreader arm assembly 114 is described in further detail below in relation with FIGS. 3A-3E. In brief overview, the spreader arm assembly 114 can include a spreader arm 122 mechanically coupling the motor 110 to the blade assembly 106. The spreader arm assembly 114 can include a member or structure 124 mechanically coupled or secured to the spreader arm 122 and designed, adapted, arranged, structured, or configured to trigger or one or more sensors of the apparatus 100. The member 124 can be referred to herein as a sensor trigger 124 or a sensor triggering member 124.

The apparatus 100 can include one or more sensors, such as sensors 126 and 128 to monitor or detect one or more positions of the blade assembly 106, the spreader holder(s) 107, the spreading blades 108 or the spreader arm 122. As depicted in FIG. 1B, the smearing apparatus 100 can include two sensors 126 and 128 positioned or arranged to detect presence of the blade assembly 106 at the first position and at the second position, respectively. For instance, the sensor 126 can be arranged or positioned (e.g., inside the housing 102) to detect the member 124 when the blade assembly 106 is at the first position and the sensor 128 can be arranged or positioned to detect the member 124 when the blade assembly 106 is at the second position. The sensors 126 and 128, can be light sensors, such as infrared (IR) sensors. Each of the IR sensors can include a corresponding IR light transmitter and a corresponding IR light receiver.

The sensor trigger structure 124 can be structured and secured to the spreader arm 122 such that when the blade assembly 106 is at the first position, the sensor triggering member 124 blocks or interferes with a signal, e.g., IR light, emitted by the transmitter of the sensor 126. When the blade assembly 106 is at the second position, the sensor triggering member 124 can block or interfere with the signal, e.g., IR light, emitted by the transmitter of the sensor 128. The blocking of or interference with the signal emitted by the transmitter of the sensor 126 or the sensor 128 can affect the signal detected or received by the corresponding detector or receiver. The processor or the controller of the apparatus 100 can receive signals from the sensors 126 and 128, and use the received signals to detect the presence of the blade assembly 106 at the first position or at the second position, respectively.

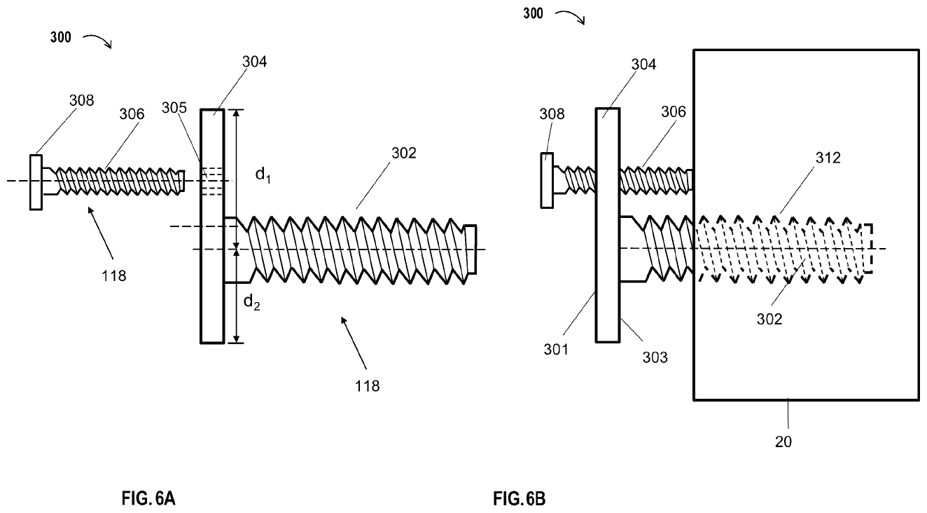

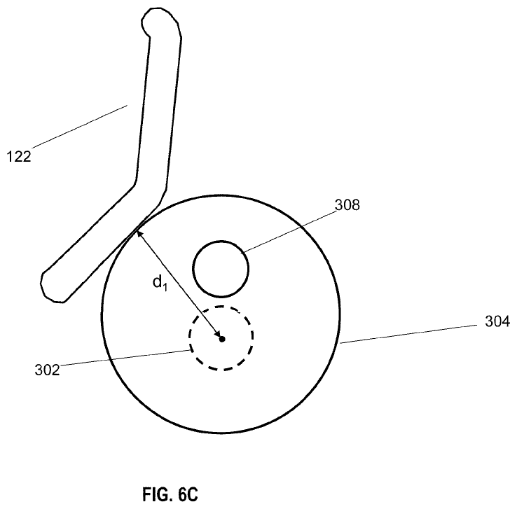

The apparatus 100 can include one or more screws or structures positioned, arranged or fixated to restrict the motion of the arm assembly 114 at one or more predefined arm positions. For instance, the apparatus 100 can include a screw 116 positioned to restrict motion of the arm assembly 114 at a corresponding arm position that corresponds to the first position of the blade assembly 106. The apparatus 100 can include an eccentric screw 118 positioned to restrict motion of the arm assembly 114 at a corresponding arm position that corresponds to the second position of the blade assembly 106. As described in further detail below in relation to FIGS. 6A-6C, the eccentric screw 118 can include a screw having a screw head and a shaft extending outwardly at a portion of a surface or an end of the screw head that is offset from a center axis of the screw head. The screw head can include or define an opening extending across the screw head and configured to receive a second screw 119.

The screws (also referred to as blocking structures or hard-stop structures) 116 and 118 can restrict the motion of the arm assembly 114 or the blade assembly to prevent damage to the spreading blade(s) 108, the slide(s) 10 or the sample(s) to be spread or smeared on the slide(s) 10. The blocking structure(s) 116 and/or 118 can include a screw, a bolt, a nut, a protrusion or some other structure that is arranged or positioned to restrict movement of the spreader arm 122 at one or more corresponding position(s). For example, The screw 116 can be arranged (e.g., fixated to a structure of the apparatus 100) to restrict or block backward movement of the spreader arm 122 when the blade assembly 106 reaches the first position (or default or home position depicted in FIGS. 1A-B) and therefore prevent potential damage to the spreading blade(s) 108 and/or scratching the slide(s) 100 (e.g., in case the spreading blade(s) 108 moves farther backward and pushes against the slide(s) 10 or other structure).

The eccentric screw 118 can be arranged to restrict or block forward movement of the spreader arm 122 when the blade assembly 106 reaches the second position where the sample is expected to be placed. The use of an eccentric screw 118 allows for adjusting or calibrating the position at which movement of the spreader arm 122 or the blade assembly 106 is to be restricted or blocked. This allows for calibration of the stop position, e.g., after replacing the spreading blade(s) 108 to accommodate for potential difference or variation in blade size, when using a different type of slides 10 (e.g., with different thickness) or for other reasons requiring calibration of the second position or the corresponding arm position.

The blocking structures can be secured or fixed to a board or an inner structure of the apparatus 100 or the housing 102. In some implementations, the motor 110 can be designed, adapted, arranged, structured, or configured to stop when the spreader arm 122 is blocked by one of the blocking structures or when a signal is received from one of the IR sensors indicating that the blade assembly 106 or the spreading blades 108 reached the first or second position. In some implementations, the apparatus 100 may include various other suitable braking mechanism, as known in the art, for the purpose of limiting the movement of the spreader arm 122, the blade assembly 106 or the spreading blades 108 beyond predefined positions (e.g., first and second positions associated with the screw 116 and the eccentric screw 118 in FIG. 1B).

The housing 102 can include an opening 130 facing or aligned with a position (or the head) of the eccentric screw 118 to adjust an orientation of the eccentric screw and therefore calibrate the second position of the blade assembly 106. The opening 130 can provide accessibility and ease of use for the operator or user to access the eccentric screw 18 without the need to dismantle or disassemble the housing 102. The orientation of the eccentric screw 118 can be adjusted (e.g., tightened or loosened) by loosening the second screw 119, rotating the eccentric screw 118 and tightening the second screw again to prevent undesired rotation of the eccentric screw 118.

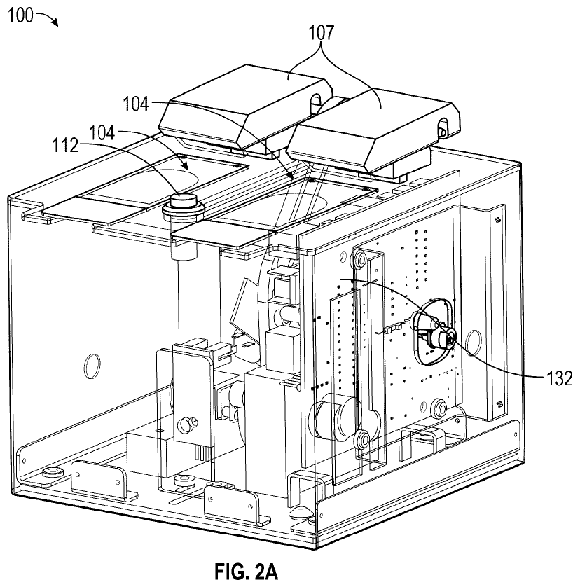

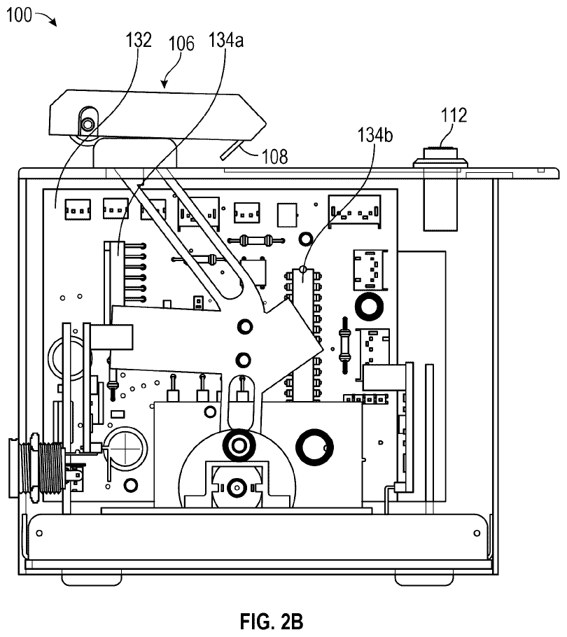

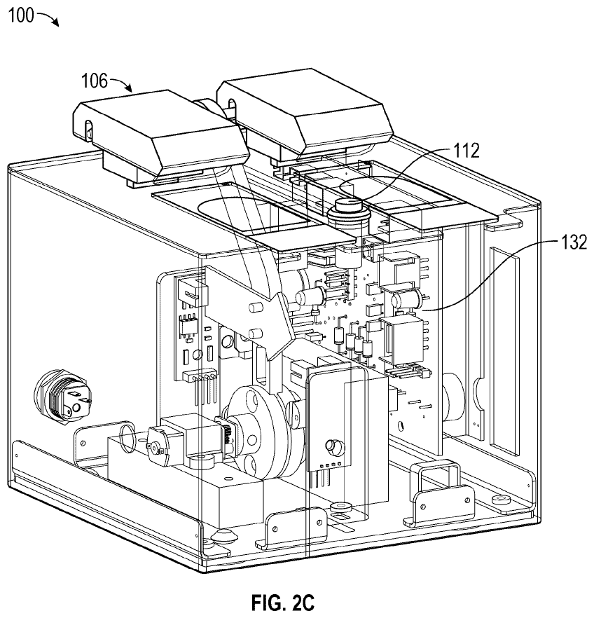

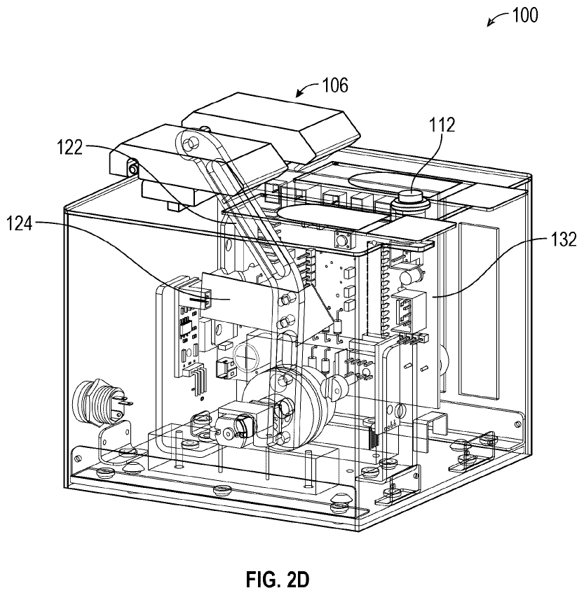

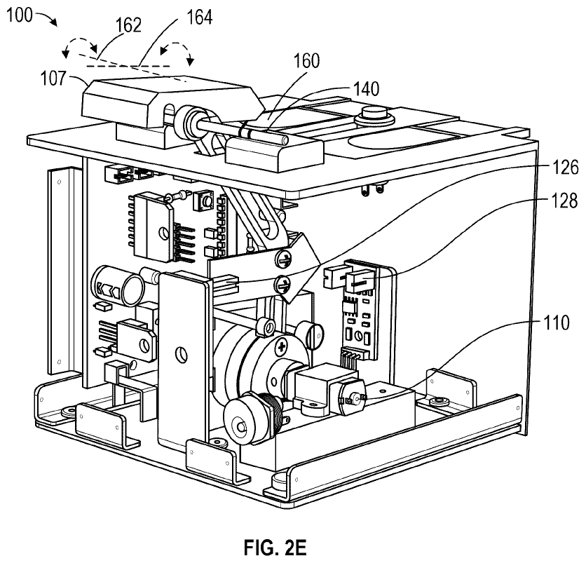

FIGS. 2A-2E depict various internal or transparent views of the apparatus 100. Two slides with smeared samples are shown to be placed in the recess regions (or slide slots 104) of the apparatus 100.

The apparatus 100 can include a circuit board 132. The circuit board 132 can include or host electronic circuitry responsible for orchestrating, controlling and/or managing various functions or operations of the apparatus 100, such as actuating and/or deactivating the motor 110, controlling the direction of the rotational motion of the motor 110, controlling the speed of the motor 110, controlling the blade assembly 106 motion or speed, acquiring settings parameters and/or controlling the smearing process according to settings' parameters, among other functions. The circuit board can include one or more processors, one or more controllers, a memory or a combination thereof. The memory can include executable instructions for controlling operations of the apparatus 100 or components thereof. The motor 110 and/or motor actuator 112 can be communicatively coupled to the circuit board 130 or components thereof (e.g., processor(s) or controller(s)).

The circuit board 132 can include various circuit components, such as circuit components 134a and 134b that may be integral to the processing of electronic signals to execute the smearing operations. The circuit components 134a and 134b can include microprocessors, controllers, memory modules, capacitors, resistors, and connection ports, which together form the control and processing unit of the apparatus. The microprocessors can manage the operational logic and sequence of actions, while the memory modules may store the firmware and operational parameters. Capacitors and resistors can manage the power supply and electrical flow, ensuring stability and efficiency of the circuit. Connection ports may serve as interfaces for external communication, enabling the apparatus to link with other devices or networks for data transfer and remote operation commands. These circuit components 134a and 134b can allow for precise control of the smearing process, ensuring consistency and reliability in sample preparation.

FIGS. 3A-3E depict various views of the spreader arm assembly 114, according to an example embodiment of the current disclosure. As discussed above, the sensor trigger structure can be secured to the spreader arm 122. The spreader shaft can mechanically couple the spreader arm 122 to the spreader holders. In brief overview, the spreader arm assembly 114 can include the spreader arm 122 mechanically coupling the motor 110 to the blade assembly 106. The spreader arm 122 can serve as the primary moving part that directly influences the motion of the blade assembly 106. The spreader arm assembly 114 can include the sensor triggering member 124 arranged to interact with the sensors 126 and 128 or interfere with corresponding signals, e.g., to monitor or detect the presence of the spreader arm at predefined position(s). The spreader arm assembly 114 can include a shaft 140 that can function as the connecting element between the spreader arm 122 and the blade assembly 106, translating the motor's movements into the desired action (e.g., a translational motion of the blade assembly 106). The spreader arm assembly 114 can include a shaft bush 142 that can provide a low-friction surface for the shaft 140 to move within.

The spreader arm assembly 114 can include a bearing coupler 144 and a shaft coupler 146. The shaft coupler 146 can be designed, adapted, arranged, structured, or configured to provide a mechanical coupling to a shaft of the motor 110. The bearing coupler 144 can mechanically couple the spreader arm 122 to the shaft coupler 146. The bearing coupler 144 and a shaft coupler 146 can facilitate or provide the coupling between the motor 110 or the motor shaft and the spreader arm 122. The spreader arm assembly 114 provides smooth and efficient transfer or conversion of motion from the motor 110 to the blade assembly 106. The bearing coupler 144 and the shaft coupler 146 can aid in maintaining the structural integrity of the motion transfer mechanism, allowing for a seamless interface between the motor 110 and the spreader arm assembly 114. The design of the couplers can contribute to the overall smooth and controlled motion of the blade assembly 106, which can allow for the consistent quality of the smears produced by the apparatus 100.

The spreader arm 122 can be mechanically coupled to the rod or shaft 140 to which the blade assembly 106 is mechanically coupled. The spreader arm 122 can be mechanically coupled to the rod 140 at a position between two spreader holders 107. When the spreader arm 122 moves, it can cause the rod 140 to move, which in turn can cause the blade assembly 106 to move across the slides 10. In some implementations, the blade assembly 106 or the spreader holders 107 can be designed, adapted, arranged, structured, or configured to rotate (e.g., with an angle range) around the rod 140. Stated differently, the blade assembly 106 or the spreader holders 107 can be configured to rotate about a longitudinal axis extending along a length of the rod. Such rotation provides rotational motion flexibility to the blade assembly 106 or the spreader holders 107 and prevent or mitigate excessive pressure or force by the spreading blade(s) 108 on the slide(s) 10, e.g., due to marginal variation in the thickness of the slide(s) 10 or marginal variation of one or more dimensions of the spreading blade(s) 108. The rotational flexibility of the blade assembly 106 or the spreader holder(s) 107 prevents or at least mitigates damage to the sample, the slide(s) 10 and/or the spreading blade(s) 108.

In some implementations, the blade assembly 106 or the spreader holder(s) 107 can have some rotational flexibility (e.g., within a range of rotational angles) along two transverse axes 136 and 138 as shown in FIG. 2E. A first rotational axis 162 can extend along a longitudinal axis of the rod 140. A second rotational axis 164 can be transverse (e.g., perpendicular) to the first rotational axis 162. The rotational axis 164 can extend along a longitudinal dimension of the corresponding slide 10 to enable marginal inclination of the corresponding spreading blade along a width of the slide 10. Such rotational flexibility (or rotational wiggle) allows the blade assembly 106, the spreader holder(s) 107 and/or the spreading blade(s) 108 to adjust or adapt the respective orientation(s) and/or position(s) according to the top surface 160 of the slide(s) 10 (e.g., the surface on which the sample or specimen is placed and/or on which the smear is to be formed), which prevents excessive pressure by the spreading blade(s) 108 on the slide(s) 10 and therefore avoids or mitigates damage to the sample, the slide(s) 10 and/or the spreading blade(s) 108. In particular, the rotational flexibility along the axis 162 (extending along a longitudinal axis of the rod 140) allows the spreading blade 108 to adapt or adjust its position according to (or based on) variation in the thickness of the corresponding slide 10 along the length of the slide 10. The rotational flexibility along the axis 164 (extending along a longitudinal dimension of the corresponding slide 10) allows the spreading blade 108 to adapt or adjust its inclination along the width of the corresponding slide 10 according to (or based on) variation in the thickness of the slide 10 along the width of the slide 10.

FIG. 3A shows the angle between the spreading blade(s) 108 and the surface or region receiving the slide 10 as angle A. The angle A can represent the angle between the spreading blade 108 and the top surface(s) 160 of the corresponding slide 10. The angle A is facing the sample or specimen to be spread. In some implementations, the angle A can be an acute angle. The angle can be between 20 degrees and 60 degrees. In some implementations, the angle can be between 25 degrees and 53 degrees. By positioning or arranging the spreading blade 108 to be at an acute angle A relative to the corresponding slide 10 or surface or region receiving the slide 10, the sample (e.g., blood sample) 152 on the slide 10 can flow or propagate along or on the surface 166 of the spreading blade 108 facing the corresponding slide 10 and/or the corresponding sample 152 during the waiting period when the spreading blade 108 is in contact with the sample 152. The surface 166 of the spreading blade 108 facing the corresponding slide 10 and/or the corresponding sample 152 is typically a smooth surface leading to a faster flow of the sample along the width of the slide 10.

When the spreading blade 108 is positioned and/or oriented such that the angle A (between the spreading blade 108 and the corresponding slide 10 and facing the corresponding sample 152) is an obtuse angle, the side or surface 168 of the spreading (defining the thickness of the spreading blade 108) will be facing the corresponding slide 10 and/or the corresponding sample 152. As such positioning the spreading blade 108 such that the angle A (between the spreading blade 108 and the corresponding slide 10 and facing the corresponding sample 152) is an obtuse angle causes the sample (or blood sample) 152 to propagate along a surface 168 (e.g., the side or surface defining the thickness of the spreading blade 108 and facing the slide 10) of the spreading blade 108. The surface 168 is typically a rough surface due to cutting, which leads to relatively slow flow or propagation of the sample along the transverse surface. During manufacturing of the spreading blade 108, a glass sheet (or a sheet of other material) is cut along the surface 168. Even when polished, the surface 168 may still not be as smooth as the surface 166 of the spreading blade 108. Therefore, by positioning or arranging the spreading blade(s) 108 to be at an acute angle A relative to the corresponding slide 10 or surface or region receiving the slide 10, the quality of the smear 154 can be enhanced.

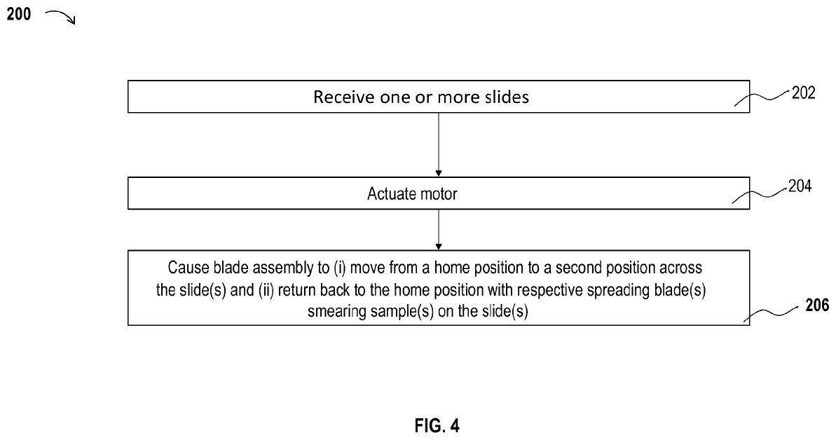

Referring now to FIG. 4, a flow diagram illustrating a method 200 automatic smearing of one or more samples (e.g., blood samples) s shown, according to example embodiments of the current disclosure. The method 200 can include receiving one or more slides 10 at one or more structures 104 (STEP 202) and actuating a motor 10 mechanically coupled to a blade assembly 106 (STEP 204). The method 200 can include causing, responsive to actuating the motor 110, the blade assembly 106 to (i) move from the first position (also referred to as home position) to the second position, and (ii) return from the second position to the first position (STEP 206). The method 200 can be executed by the apparatus 100 as discussed above in relation to FIGS. 1A-1B, 2A-2E and 3A-3E.

The method 200 can include causing the blade assembly 106 to pause at the second position for a waiting period before returning from the second position to the first position. The method 200 can include determining the waiting period according to at least one of an input parameter specifying the waiting period or an amount of time during which the motor actuator 112 of the motor 110 is actuated.

In some implementations, the motor 110 can be mechanically coupled to the blade assembly 106 via the arm assembly 114 and the method 200 can include restricting, by an eccentric screw 118, motion of the arm assembly 106 at an arm position that corresponds to the second position of the blade assembly 106. As discussed above, the eccentric screw 118 can include a first screw including a screw head and a shaft arranged at an offset relative to an axis of the screw head. The screw head can include or define an opening configured to receive the second screw 119. The method 200 can include adjusting an orientation of the eccentric screw 118 to calibrate the second position.

It is to be noted that the various features, implementations and/or embodiments described above in relation with FIGS. 1A-1B, 2A-2E and 3A-3E.

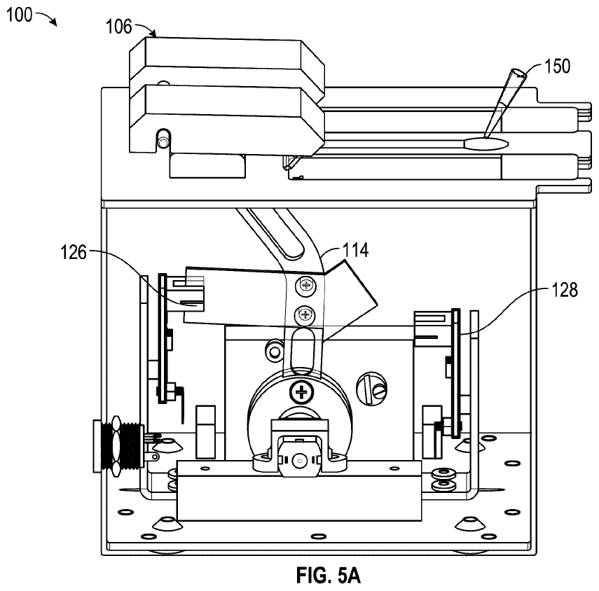

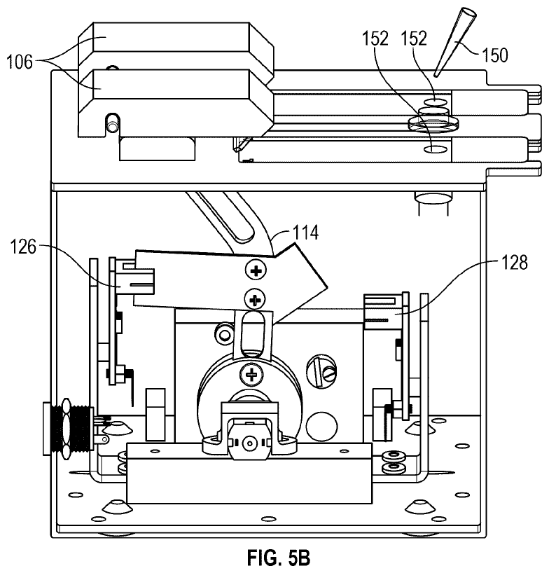

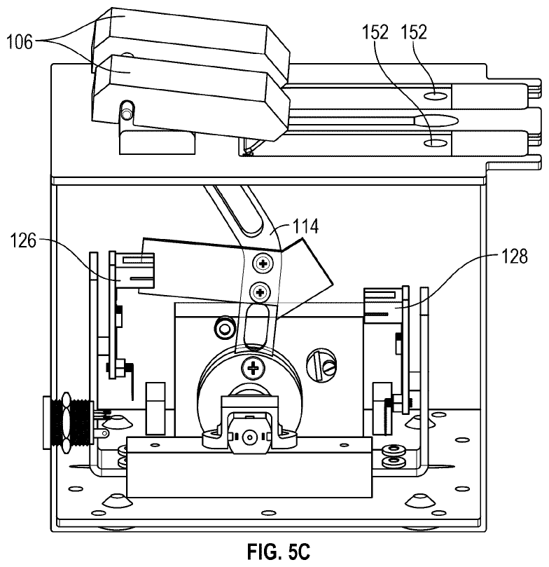

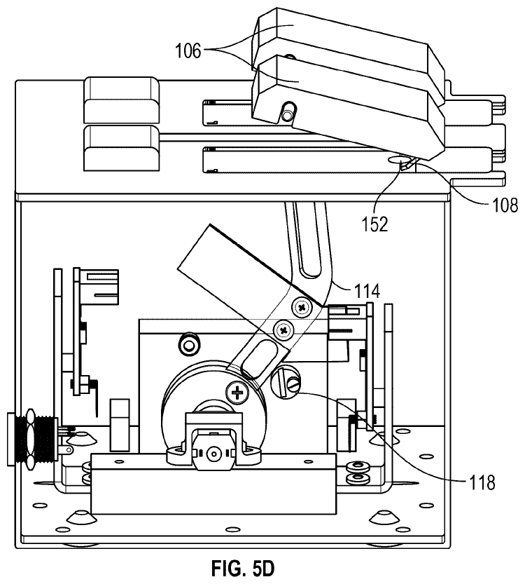

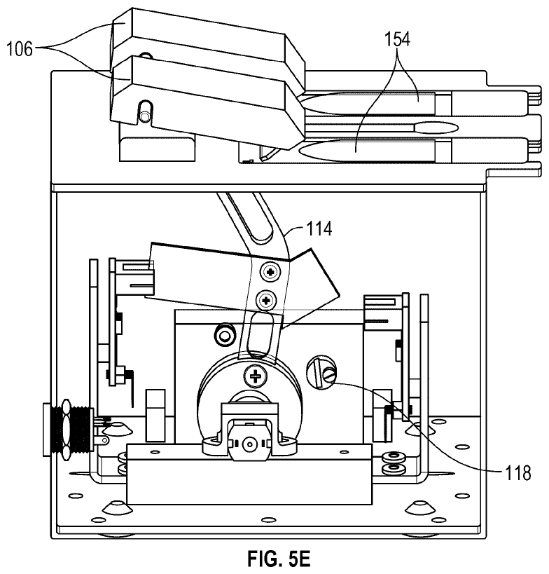

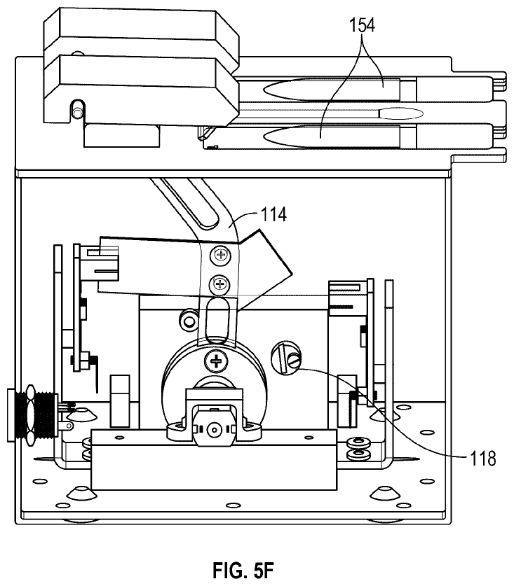

FIGS. 5A-5F depict various states of the apparatus 100 corresponding to different steps of the method 200. Referring now to FIGS. 5A-5F, the method 200 can include a user placing the one or more slides 10 in one or more slide slots 104 of the smearing apparatus 100 (STEP 202). The slide slots can be arranged at the top surface 120 of the housing 102. The user can clean the slide(s) 10 or use pre-cleaned slides. The slides 10 can be labelled at a labeling region. For example, for each slide, a corresponding label can be placed on the corresponding labeling region/area. The slide(s) 10 can be labeled using barcodes and/or text. FIG. 5A shows the smearing apparatus 100 with two slides 10 placed in two slide slots 104 of the smearing apparatus 100. The blade assembly 106 is positioned at the home position at this stage.

The user can place, on each slide 10, a corresponding sample (e.g., a corresponding blood drop or sample) 152. The user can use a pipette 150 to place the sample 152 on the slide(s) 10. FIG. 5B shows the smearing apparatus 100 with a blood drop or sample 152 placed on each of the two slides 10 located in two slide slots of the smearing apparatus 100. In FIGS. 5A-5C, the spreader mount structures 107 (or spreader holders) are still positioned at the home position at this stage.

The method 200 can include actuating or triggering the motor 110, e.g., via the motor actuator 112 (STEP 204). The motor actuator 112 can include at least one of a push button, a switch, a roller, a slider, a touch screen, a user interface or a mobile application, among others. For instance, a user can press and release the push button of the apparatus 100 to actuate the motor 110 or initiate the smearing process. When actuated, the motor 110 can cause the blade assembly 106 to move from the first position to the second position, and then move back to from the second position to the home position (STEP 206). FIG. 5C depicts the start of the movement of the blade assembly 106 from the first position to the second position after actuating the motor 110.

FIG. 5D illustrates an example of the blade assembly 106 at the second position. The motor 110 can be actuated to first rotate in a first direction and cause the blade assembly 106 to move from the first position to the second position. In some implementations, once the blade assembly 106 reaches the second position, the motor 110 can stop for a waiting period. The motor 110 can be actuated (e.g., by a controller or processor) after the waiting period to rotate in the reverse direction and cause the blade assembly 106 to move back from the second position to the home position.

In some implementations, the waiting period can be programmed and can be adjustable. For instance, a user of the apparatus 100 can adjust the waiting period via touch screen or other input device of the apparatus 100. For example, the user can select a longer waiting period for relatively thicker blood samples. The waiting period allows each blood sample drop placed on a slide to spread across the slide 10 (e.g., along the corresponding spreading blade 108 in contact with the slide 10). Once the waiting period ends, the controller or processor can automatically actuate the motor 110 to rotate in the reverse direction and cause the blade assembly 106 to move back from the second position to the first position.

In some implementations, the waiting period can be controlled manually by the user. The user can press the push button to actuate the motor to rotate in the forward direction and cause the blade assembly 106 to move from the home position to the second position. The motor will automatically stop once the blade assembly 106 reaches the second position. The user can release the push button to actuate the motor to rotate in the reverse direction and cause the blade assembly 106 to move back from the second position to the home position. In some implementations, in response to the user releasing the push button, the blade assembly can move back from the second position to the home position either via the motor or via another mechanism that can controllably cause the blade assembly to move back from the second position to the home position. As such, the waiting period is determined by the time during which the push button is pressed minus the time taken for the blade assembly 106 to move from the home position to the second position. Pressing the push button for a longer time period leads to a longer waiting time duration for the blade assembly 106 at the second position.

In some implementations, when the blade assembly 106 moves from the first position to the second position, the sensor 128 can detect, via the sensor triggering structure 124, the blade assembly 106 reaching the second position and can send a signal to the controller (e.g., motor controller) or processor indicative of the presence of the blade assembly 106 at the second position. In response, the controller or processor can stop or deactivate the motor 110. When the blade assembly 106 moves back from the second position to the first position, the sensor 126 can detect, via the sensor triggering structure 124, the blade assembly 106 reaching the first position and can send a signal to the controller (e.g., motor controller) or processor indicative of the presence of the blade assembly 106 at the first position. In response, the controller or processor can stop or deactivate the motor 110.

As the blade assembly 106 moves in a forward direction (from the home position to the second position) by means of the spreader arm assembly 114 and the motor 110 and reaches the second position, the sensor trigger starts to block the signal (e.g., IR light) from the sensor 128. Similarly, as the blade assembly 106 moves in a backward direction (from the second position to the home position) by means of the spreader arm assembly 114 and the motor 110 and reaches the home position, the sensor trigger 124 starts to block the signal from the first sensor 126.

In some implementations, the blade assembly 106 and the corresponding spreading blade(s) 108 can be designed, adapted, arranged, structured, or configured such that the spreading blades 108 come in contact (or within few micrometers) with the top surface(s) 160 of the corresponding slide(s) 10 when the blade assembly 106 is moving forward from the home or first position to the second position. The spreading blades 108 can come in contact with the surfaces of the corresponding slides 10 when the blade assembly 106 is moving backward from the second position to the home position.

The block structures 116 and 118 can restrict movement of the spreader arm 122 at the predefined positions. When the motor is stopped or turned off, the spreader arm 122 may still continue moving due to gained momentum. This can lead to undesired motion and/or position inaccuracies of the blade assembly 106 and the corresponding spreading blades 108. The blocking structures 118 causes the spreader arm 122 to stop forward motion when the blade assembly 106 reaches the second position. The blocking structures 116 causes the spreader arm 122 to stop backward motion when the blade assembly 106 reaches the home or first position. The block structures 116 and 118 allow for better control of the stopping positions of the blade assembly 106 and the corresponding spreading blades 108.

FIG. 5C depicts initiation of forward motion of the blade assembly 106 from home position, and FIG. 5D depicts the blade assembly 106 reaching the second position. in some implementations, the spreader arm assembly 114 can be designed, adapted, arranged, structured, or configured such that the blade assembly 106 is inclined at an angle at the second position and/or while moving between the first and second positions. The inclination can cause each spreading blade 108 to come in contact with the surface of the corresponding slide 10. During the waiting period at the second position, the blood can spread along the blade 108 across the slide 10. FIG. 5E depicts the spreader blade assembly 106 moving back to the home position from the second position. The spreading blades 108 which are in contact with (or within few micrometers from) surfaces 160 of corresponding slides smear the blood drops along the corresponding slides leading to a blood smear 154 forming on each slide. FIG. 5E depicts the blade assembly 106 reaching the second position and FIG. 5F depicts the end of the smearing process. The blade assembly 106 can move back to a straight position (no inclination or tilt) and may cause the corresponding blades 108 to move away from the surfaces of the corresponding slides 10.

The housing unit of the smearing apparatus 100 can include a powering unit for providing power to the apparatus 100, including the servo motor, and sensors thereof. The powering unit can be in the form of a powering switch positioned on the top surface of the housing unit, and connected to a means of electricity, a battery, or the like.

In some embodiments, the housing unit may be formed of a material such as a metal, a composite material or any other material suitable to make the assembly a reusable unit, and make it applicable to cleaning and sterilization.

In some embodiments of the current disclosure, the apparatus 100 can include a controller adapted to improve the precision and/or accuracy of the smearing device. Particularly, the controller is adapted to control the waiting duration at the second position, and/or the speed of the servo motor very accurately, so that the smearing accuracy of the apparatus 100 can be further improved, and the device is more convenient to use.

The present disclosure relates to a smearing apparatus 100 for performing automatic smearing. The apparatus 100 facilitates the simultaneous preparation of multiple peripheral smears, e.g., blood smears. The apparatus further facilitates the production of high-quality blood smears with very little experience needed. With just a single action, the apparatus 100 distributes the cells evenly on the smear. Smears with consistently high quality can also be produced by less experienced technicians in a reproducible manner. The apparatus 100 allows for adjusting or defining setting parameters of the smearing process, e.g., based on the type or characteristics of the sample or specimen to be smeared.

### B. Eccentric Screw

FIGS. 6A-6C depict various views of the eccentric screw assembly 300, according to an example embodiment of the current application. The eccentric screw assembly 300 can include a first screw (or eccentric screw) 118 including a screw head 304 having a first end (or first surface) 301 and a second end (or second surface) 303, and a shaft (or screw body) 302 extending outwardly from a portion of the second end that is offset from a center of the screw head 304. The screw head 304 can define (or can include) an opening 305 extending from the first end 301 to the second end 303 and configured to receive a second screw 119. The axis of the opening 305 can be parallel to a longitudinal axis extending through the shaft 302.

In some implementations, the eccentric screw assembly 300 can include the second screw 119 and the second screw 119 can be sized to be disposed within the opening 305. The screw head 304 can include a female thread around the opening 305 and the second screw 119 can have a male thread 306 structured to engage the female thread.

The second screw 119 can be arranged substantially parallel to the first screw 118 when inserted through the opening 305 defined by the screw head 304 of the first screw 118. The opening 305 defined by the screw head 304 can also be substantially parallel to the opening through which the first screw 118 is inserted.

The first screw 118 can be designed, adapted, arranged, structured, or configured to engage an object (or block) 20. The second screw 119, when inserted into the opening 305, can cause to lock the first screw 118 against the object 20 to prevent loose rotation of the first screw 118. The second screw 119 can include a corresponding screw head 308 and a corresponding shaft 306. An end of the corresponding shaft 306 can be configured to engage the object 20.

The first screw 118 can be designed, adapted, arranged, structured, or configured to engage the object 20 and the second screw 119 can be configured to lock the first screw 118 against the object 20 to prevent loose rotation of the first screw 118.

The eccentric screw assembly 300 can be designed, adapted, arranged, structured, or configured to mechanically engage the object 20. The screw head 304 can provide a mechanical hard stop, e.g., to the spreader arm 122, as depicted in FIG. 6C. The mechanical hard stop can be adjusted by rotating the first screw 118. The shaft 302 can include a male thread 3structured to engage a female thread 312 of the object 20.

The eccentric screw 118 can be positioned to restrict the motion of the spreader arm 122 or act as a hard stop at a corresponding position. By restricting the motion of the spreader arm 122 or the arm assembly 114, the blade assembly 106 or its component can stop at the second position when moving from the first position to the second position. The eccentric screw 118 can be accessed by the hole or opening 130 in the housing 102 to allow for easy access and calibration using a tool such as a screwdriver.

The mechanical hard stop can be adjusted by rotating the eccentric screw 118. By adjusting the orientation of the eccentric screw 118, the position(s) of the blade assembly 106 or the spreading blade(s) 108 can be adjusted to the desired second position. The eccentric screw 118 can act as an adjustable mechanical hard stop. The eccentric screw can restrict the motion of the arm assembly at a third position causing the blade assembly 106 to stop at the second position when moving from the first position to the second position.

The difference between the distances d₁ and d₂ is due to the offset between the central axis of the shaft 302 and the centra axis of the screw head 304. In FIG. 6C, the distance d1 may be greater than a distance d2. The eccentricity can allow for the adjustment of mechanical hard stop when the eccentric screw 118 is rotated. The eccentricity can allow for a range of adjustments by rotating the eccentric screw 118 and consequently, the mechanical hard stop can be fine-tuned. The variance in distances is crucial for the calibration of the mechanical hard stop or the calibration of the second position, ensuring that the blade assembly 106 stops precisely at the designated second position.

The eccentric screw head 304 can include or define a hole or opening 305 that can receive the second screw. For example, the opening 305 can include a female thread and can receive the second screw body 306 can include a male thread structured to engage the female thread of the hole 305. The second screw 119 can be parallel to the first screw when inserted into the opening 305 in the screw head 304 of the eccentric screw 118.

The shafts may include a threading pattern compatible with corresponding internal threads of another component, allowing the two parts to be securely joined. The threaded connection can be essential for maintaining the desired tension and position once adjustments have been made using the eccentric screw.

As shown in FIG. 6B, the shaft 302 can include a male thread structured to engage a female thread 312 in an object. The eccentric screw assembly 300 can mechanically engage the object. The second screw can lock the first screw against the object to prevent loose rotation of the first screw. In the eccentric screw assembly, end of the second screw body 306 can engage with the object.

FIG. 6C illustrates the interaction between the eccentric screw 118 and spreading arm 122 or the arm assembly 114. The spreading arm 122 is shown in relation to the eccentric screw head 304, indicating the manner in which motion may be restricted. When the eccentric screw rotates or pivots around the shaft 302, the hard stop position relative to the center of the shaft 302 can, which makes the eccentric screw effectively functioning as a customizable mechanical stop.

It should be appreciated that the eccentric screw assembly 300 can be used in other applications beyond the smearer device 100. In particular, the eccentric screw assembly 300 can be used in any device or apparatus and this disclosure is not intended to limit the application of the eccentric screw assembly 300 to the smearer device 100 described herein.

### C. Flange-Based Sensor

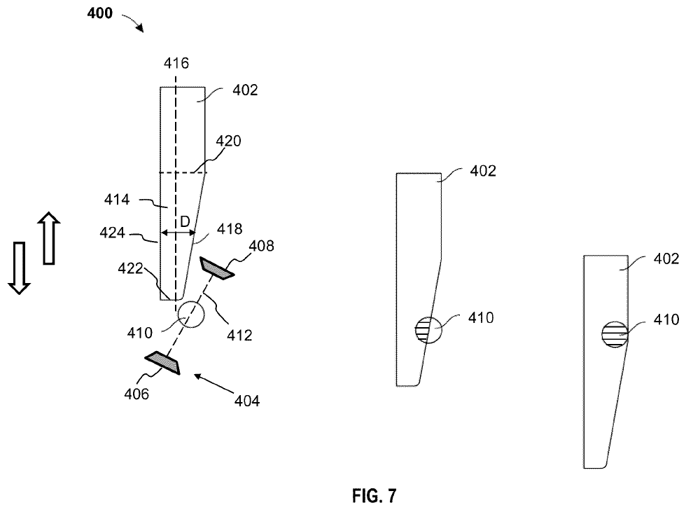

FIG. 7 depicts a flange-based sensor assembly 400, according to an example embodiment of the current disclosure. The sensor assembly 400 can include a flange member 402 and sensor 404 including a transmitter 406 and detector 408. The transmitter can be positioned or arranged to emit a signal beam 410 along a first axis (or first direction) 412. The detector 408 can be positioned relative to the transmitter 406 to detect the signal beam 410 emitted from the transmitter 406. The flange member 402 can include a tapered region 414 movable along a second axis (or second direction) transverse to the first axis 412. The arrows depict the two directions of motion of the flange member 402 or the tapered region 414. As the tapered region 414 moves from a first position to a second position along the second axis, the tapered region 414 blocks an increasing (or decreasing) portion of the signal beam 410 from being detected by the detector 408. The detected portion of the signal beam (detected by the detector 408) is used to determine a position of the flange member 402 or a position of an object to which the flange member 402 is coupled or secured. In some implementations, the flange member 402 or tapered region 414 can be arranged to move along a longitudinal axis 416 of the flange member 402.

FIG. 7 depicts three different positions of the flange member 402 relative to a cross section of the signal beam 410. The three different positions of the represent three different scenarios of the flange member 402 (or the tapered region 414) interfering or intersecting with the signal beam 410. In the first scenario (left-most), the flange member 402 (or the tapered region 414) does not intersect the signal beam 410. In the second scenario (middle), the flange member 402 (or the tapered region 414) partially intersects (or overlaps with) the signal beam 410. In the third scenario (right-most), the flange member 402 (or the tapered region 414) fully intersects (or overlaps with) the signal beam 410. In this last scenario, the signal beam 410 can be fully reflected from the flange member 402.

The tapered region 414 of the flange member 402 can have a varying dimension (e.g., a width or diameter), depicted as D in FIG. 7, along the longitudinal axis 416 of the tapered region 414 (or of the flange member 402). For instance, the tapered region 414 can have a tapered side or tapered edge 418 extending from a first end 420 of the tapered region 414 to a second end 422 of the tapered region 414. The tapered edge 418 can be oriented at an angle between 0 and 90 degrees relative to the longitudinal axis 416 of the tapered region 414. In some implementations, the angle of the tapered edge can be between 30 and 85 degrees. In some implementations, the tapered edge can have curved shape, e.g., instead of straight line. The distance measured from any point on the longitudinal axis 416 of the flange member 402 (or tapered region 414) to a location on the tapered edge 418 along a line perpendicular to the longitudinal axis 416 increases along the longitudinal axis 416 of the flange member 402. In some implementations, the tapered region 414 can be trapezoidal or can have a trapezoidal shape.

As the flange member 402 (or the tapered region 414) moves along the second axis (or second direction) the portion of the signal beam 410 blocked or reflected by the flange member (or the tapered region 414) varies. In FIG. 7, the hashed region of the signal beam 410 represents the portion of the signal beam 410 that is blocked or reflected by the flange member (or the tapered region 414). In particular, the overlap (hashed region) between the cross-sectional area of the signal beam 410 and the tapered region 414 varies as the flange member 402 (or the tapered region 414) moves along the second axis.

The tapered region 414 or the tapered edge 418 allows for a varying degree of obstruction or reflection of the signal beam 410 as the flange member 402 moves along the second axis (e.g., axis 416). As the flange member 402 moves along the second axis, the cross-sectional region of the signal beam 410 (hashed region) overlapping with (or blocked by) the flange member 402 or the tapered region 414 changes, e.g., increases or decreases depending on the direction of motion of the flange member 402. Consequently, the amount or portion of the signal beam 410 detected by the detector 408 varies as the flange member moves. The amount or portion of the signal beam 410 detected by the detector 408 can be used to determine the position of the flange member 402 or determine the position of an object to which the flange member 402 is coupled or secured. In some implementations, an actuator may perform an action responsive to determining that the position of the flange member 402 satisfies a predefined condition (e.g., reaching a predefined position).

In some implementations and as depicted in FIG. 7, the detector 406 can be facing the transmitter 404 and the tapered region 414 can be arranged between the transmitter 406 and the and the detector 408. In particular, the tapered region 414 can be movable (or arranged to move) along the second axis between the transmitter 406 and the detector 408. In such implementations, the detected portion of the signal beam 410 represents a portion of the signal beam 410 that is not blocked by the tapered region 414. In other words, the detected portion of the signal beam 410 is the non-hashed portion of the signal beam 410 in FIG. 7.

In some implementations, both the transmitter 406 and the detector 408 can be positioned on one side of the flange member 402. For instance, the transmitter 406 and the detector 408 can be positioned adjacent to one another and face the flange member 402. In such case, the detector 408 detects the portion of the signal beam 410 that is reflected by (or from) the flange member 402. In other words, the detected portion corresponds to the hashed region of the signal beam 410 in FIG. 7.

In some implementations, the sensor 404 can be (or can include) a light sensor including a light transmitter and a light detector. The light sensor can be an infra-red (IR) light sensor having an IR light transmitter configured or structured to emit an IR light beam. The light sensor can be an ultra-violet (UV) light sensor having an UV light transmitter configured or structured to emit an UV light beam. The light sensor can be a light sensor having a light transmitter configured or structured to emit a beam of visible light.

In some implementations, the sensor 404 can include other types of sensors, such as a radio wave sensor, a microwave sensor, an X-ray sensor or a gamma ray sensor. For instance, the transmitter 406 can emit radio waves, microwaves, X-rays or gamma rays, among other types of waves or radiation signals. The detector 408, can detect radio waves, microwaves, X-rays or gamma rays, among other types of waves or radiation signals, depending on the type of wave or radiation emitted by the transmitter 406.

In some implementations, the sensor assembly 400 can include a controller, processor or circuitry. The controller, processor or circuitry can receive an indication of the detected portion of the signal beam 410 from the detector 408. The indication can be an electric signal. In particular, the detector 408 can generate or provide the electric signal responsive to the detected portion of the signal beam 410. The detector 408 can generate or provide different electric signals for different positions of the flange member 402 (or of the tapered region 414) relative to position of the signal beam 410. For instance, the amplitude of the electric signal generated by the detector 408 can increase monotonically as the cross area or intensity of the detected portion of the signal beam 410 increases.

The controller, processor or circuit can determine, using the indication of the detected portion of the signal beam, the position of the flange member 402 or an object to which the flange member is coupled or secured. In some implementations, the sensor 404 or the detector 408 can be configured to output continuous values (or signals with continuous amplitude values) within a given range, e.g., a calibrated range between 50 and 1000. The range can be calibrated such that the smallest number of the rage corresponds to a first position and the largest number of the range corresponding to a second position of the flange member 402, where the flange member 402 moves between the first position and the second position. Each value in the range corresponds to a different position of the flange member 402 or the object to which the flange member 402 is coupled or secured. When the controller, processor or circuit obtains the output value of the sensor 404 or detector 408, the controller, processor or circuit can determine the corresponding position of the flange member 402 or the corresponding position of the object to which the flange member 402 is coupled or secured. Accordingly, the controller, processor or circuit can precisely locate the flange member 402 or the object and provide precise feedback, e.g., to another device or system, indicative of the position of the flange member 402 or the object to which the flange member 402 is coupled or secured. Therefore, the controller, processor or circuit can sensor assembly 400 can accurately monitor the position of a moving object or component in real-time, e.g., along a motion direction or path. In the case of a light sensor, the output of the sensor 404 can be indicative of the amount of light detected.

In some implementations, the flange member 402 and the sensor 404 can be mounted on or coupled to two different objects or devices whose relative position is to be monitored. For example, the flange member 402 can be mounted on a first object (or first device) and the sensor 404 can be mounted on a second object (or second device). When the first object moves relative to the second object and/or vice versa, the sensor assembly 400 can accurately monitor the relative positions of the first and second objects in real-time. In particular, the value or signal output by the sensor 404 or the detector 408 at any time instance is indicative of a corresponding relative position of the first object relative to the second object or vice versa. Each value in the range of values associated with the sensor 404 corresponds to a different position of the first object (or first device) to relative to the second object (or second device).

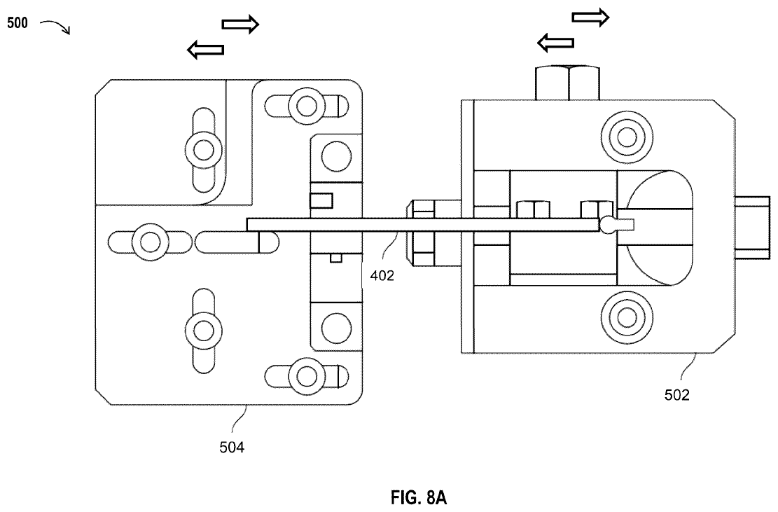

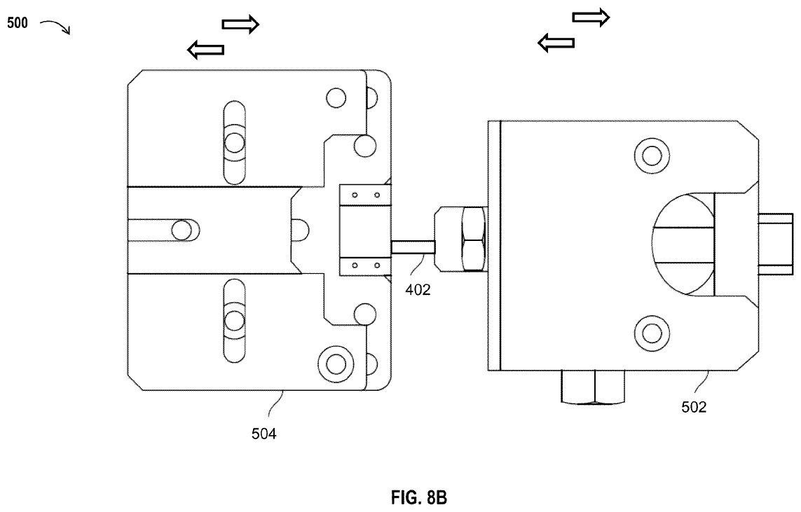

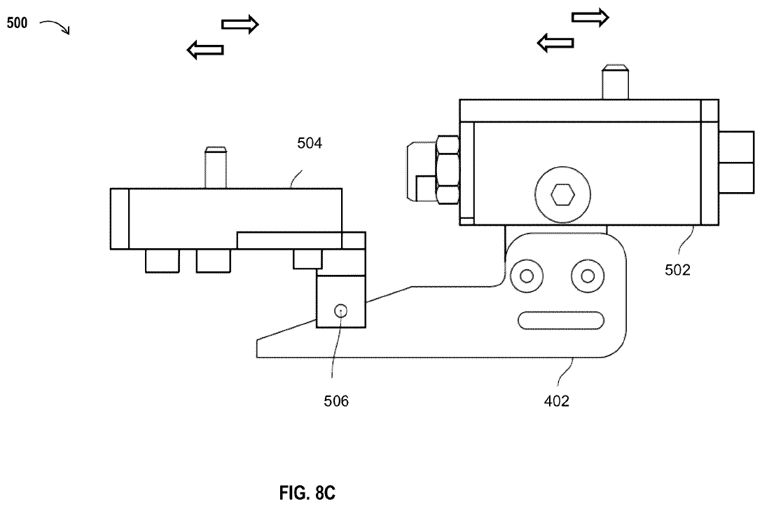

FIGS. 8A-8C depict various views of a system 500 for monitoring relative positions of two different objects or devices, according to an example embodiment of the current disclosure. FIG. 8A depicts a front view of the system 500, FIG. 8B depicts a rear view of the system 500 and FIG. 8C depicts a side view of the system 500. In brief overview, the system 500 can include a first device 502 on which the flange member 402 is mounted or to which the flange member 402 is coupled or secured, a second device 504 on which the sensor 404 is mounted or to which the sensor 404 is coupled or secured. The region 506 is indicative of the position of the cross-sectional area of the signal beam 410 emitted by the transmitter 406.

As indicated by the arrows in FIGS. 8A-8C, any of the device 502 and 504 can be moving or structured or configured to move relative to the other device. For instance, the device 504 can be stationary and the device 502 can be configured, arranged or structured to move relative to the device 504 as depicted by the corresponding arrows. In some implementations, the device 502 can be stationary and the device 504 can be configured, arranged or structured to move relative to the device 502 as depicted by the corresponding arrows. In some implementations, both devices 502 and 504 can be configured, arranged or structured to move relative to one another.

As the device 502 moves towards or away from the device 504 (and/or vice versa), the portion of the signal beam 410 obstructed by the flange member 402 varies (e.g., increases or decreases) as discussed above in relation with FIG. 7. In consequence, the detected portion of the signal beam 410 (e.g., detected by the detector 408 of the sensor 404) also varies. The signal or value output by the sensor 404 or detector 408 at any time instance can be indicative of a corresponding position of the device 502 relative to the device 504 (or a corresponding position of the device 504 relative to the device 502). Accordingly, the sensor assembly 400 or the sensor 404 can produces or generate different sensor output values (or sensor output signals) for different positions of the flange member 402 or different relative positions of the device 502 and/or device 504. The flange member 402 can be positioned or arranged such that the corresponding tapering is along the motion path of the device 502 and/or device 504.

While FIGS. 7 and 8C depict a flange member 402 having a single tapered edge 418 (or tapering along a single edge), in some implementations, the flange member 402 can have tapering along multiple edges (e.g., along two opposite longitudinal edges). The tapering can be formed according to a straight slope or according to a curve. In some implementations, the flange member 402 may not have a tapering. Instead, the flange member 402 can be orientated at an oblique angle (e.g., less than 90 degrees) with respect to the axis or direction of motion of the flange member 402. In some implementations, a combination of tapering and an oblique orientation of the flange member can be employed. It should be appreciated that an edge can correspond to or include a side.

In some implementations, the sensor assembly 400 can include the sensor 404 including the transmitter 406 configured to emit the signal beam 410 along a first axis 412 and the detector 408 facing the transmitter 406 to detect the signal beam 410 emitted from the transmitter 406. The sensor assembly 400 can include the flange member 402 including a tapered region 414 movable between the transmitter 406 and the detector 408 along a second axis transverse to the first axis 412. As the tapered region 414 moves from a first position to a second position along the second axis, the tapered region 414 blocks an increasing portion of the signal beam 410 from being detected by the detector 408. The detected portion of the signal beam 410 can be used to determine a position of the flange member 402.

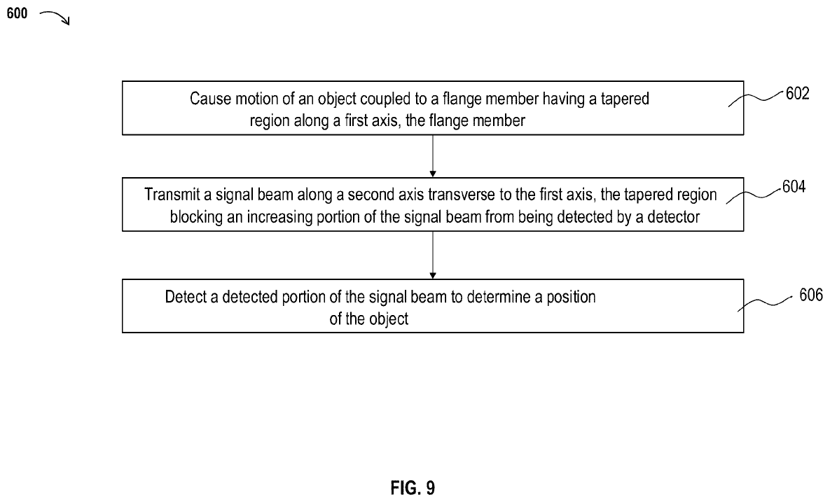

FIG. 9 shows a flow chart depicting a method 600 for position sensing, according to an example embodiment of the current disclosure. In brief overview, the method 600 can include causing motion of an object (e.g., device 502 or 504) coupled to a flange member 402 along a first axis (STEP 602), transmitting, by a transmitter 406, a signal beam 410 along a second axis 412 transverse to the first axis (STEP 604), and detecting, by the detector 408, a detected portion of the signal beam 410 to determine a position of the object, e.g., device 502 or 504 (STEP 608).

The method 600 can include causing motion of an object coupled to a flange member 402 along a first axis (STEP 602). The flange member 402 can have the tapered region 414 as described above. The object can be a device, such as device 502 or device 504 in FIGS. 8A-8C, or a component of a system. The motion of the object can be triggered or driven by a motor or some other motion actuator. As the object moves along the first axis so does the flange member 402.

The method 600 can include transmitting, by the transmitter 406, a signal beam 410 along a second axis 412 transverse to the first axis (STEP 604). The tapered region 414 can block an increasing (or decreasing) portion of the signal beam 410 from being detected by the detector 408. As discussed above, as the flange member 402 moves along the first axis, the tapered region 414 can cause gradual (or varying) obstruction of the signal beam 410.

The method 600 can include detecting, by the detector 408, a detected portion of the signal beam 410 to determine a position of the object, e.g., device 502 or 504 (STEP 608). The detector 408 or the sensor 404 can receive the detected portion of the signal beam 410. The detector 408 or the sensor 404 can generate or provide an output signal or output value indicative of the position (or relative position) of the object, responsive to the detected portion of the signal beam 410.

The method 600 can include receiving, by the controller, processor or circuit from the detector, an indication of the detected portion of the signal beam, and determining, by the controller, processor or circuit using the indication of the detected portion of the signal beam, the position of the object.

The various embodiments of the flange member 402, the sensor 404 and the signal beam 410 described above in relation to FIGS. 7 and 8A-8C are applicable to the method 600.

In some implementations, the sensor assembly 400 can be used in the smearer device 100, e.g., to track or monitor movement of the blade assembly 106 or the spreader arm 122. However, it should be appreciated that the sensor assembly 400 can be used in other applications beyond the smearer device 100. In particular, the sensor assembly 400 can be used in any device or apparatus and this disclosure is not intended to limit the application of the sensor assembly 400to the smearer device 100 described herein.

Throughout the specifications of the present disclosure, the term “comprising” means including but not necessarily to the exclusion of other elements or steps. In other words, the term comprising indicates an open list. Furthermore, all directional references (such as, but not limited to, upper, lower, inner, outer, upward, downward, inwards, outwards, right, left, rightward, leftward, inside, outside, top, bottom, above, below, vertical, horizontal, clockwise, and counter-clockwise, lineal, axial and/or radial, or any other directional and/or similar references) are only used for identification purposes to aid the reader's understanding of illustrative embodiments of the present disclosure, and may not create any limitations, particularly as to the position, orientation, or use unless specifically set forth in the claims. Moreover, all directional references are approximate and should not be interpreted as exact, but rather as describing a general indicator as to an approximate attitude.

Similarly, joinder references (such as, but not limited to, attached, coupled, connected, accommodated, and the like and their derivatives) are to be construed broadly and may include intermediate members between a connection of segments and relative movement between segments. As such, joinder references may not necessarily infer that two segments are directly connected and in fixed relation to each other.

In some instances, all numerical terms, such as, but not limited to, “first”, “second”, “third”, “fourth”, or any other ordinary and/or numerical terms, should also be taken only as identifiers, to assist the reader's understanding of the various embodiments, variations and/or modifications of the present disclosure, and may not create any limitations, particularly as to the order, or preference, of any embodiment, variation and/or modification relative to, or over, another embodiment, variation and/or modification.

As will be readily apparent to those skilled in the art, embodiments described herein may easily be produced in other specific forms without departing from its essential characteristics. The example embodiments described herein are to be considered as merely illustrative and not restrictive, the scope of the invention being indicated by the claims rather than the foregoing description, and all changes which come within therefore intended to be embraced therein. Many variations, modifications, additions, and improvements are possible. More generally, embodiments in accordance with the present disclosure have been described in the context of preferred embodiments. Functionalities may be separated or combined in procedures differently in various embodiments of the disclosure or described with different terminology. These and other variations, modifications, additions, and improvements may fall within the scope of the disclosure as defined in the appended claims.

What is claimed is:

1. An apparatus for preparing slides with samples for acquisition of measurement data by at least one analytical instrument, comprising:
one or more structures configured to receive one or more slides;
a blade assembly including one or more blades configured to prepare for measurement one or more samples on the one or more slides; and
a motor mechanically coupled to the blade assembly and disposed within a housing, the motor configured to cause the blade assembly to move from a first position to a second position and return from the second position to the first position responsive to actuating the motor,
each blade of the one or more blades is configured to prepare for measurement a corresponding sample of the one or more samples placed on a corresponding slide responsive to the blade assembly moving from the second position to the first position.

2. The apparatus of claim 1, further comprising a motor actuator including at least one of a push button, a switch or a touch screen and wherein the motor actuator is disposed on an external surface of the housing.

3. The apparatus of claim 2, wherein in response to the push button being pressed, the motor is actuated to rotate in a first direction causing the blade assembly to move from the first position to the second position, and responsive to the push button being released, the motor is actuated to rotate in a second direction opposite to the first direction causing the blade assembly to move from the second position to the first position.

4. The apparatus of claim 2, wherein the motor, responsive to actuating the motor actuator, rotates in a first direction to cause the blade assembly to move from the first position to the second position, and wherein the blade assembly, responsive to deactivating the motor actuator, moves from the second position to the first position.

5. The apparatus of claim 1, wherein the motor, in response to being actuated, causes the blade assembly to (i) move from the first position to the second position, (ii) pause at the second position for a waiting period, and (iii) return from the second position to the first position after the waiting period.

6. The apparatus of claim 5, comprising an interface, wherein the waiting period is selectable via an input parameter provided via the interface.

7. The apparatus of claim 1, comprising an arm assembly mechanically coupling the motor to the blade assembly and configured to transfer motion from the motor to the blade assembly.

8. The apparatus of claim 7, comprising an eccentric screw positioned to restrict motion of the arm assembly at a corresponding arm position that corresponds to the second position of the blade assembly, the eccentric screw comprising a first screw including a screw head and a shaft arranged at an offset relative to an axis of the screw head, the screw head defining an opening sized to receive a second screw.

9. The apparatus of claim 8, wherein an orientation of the eccentric screw is adjustable to calibrate the second position of the blade assembly.

10. The apparatus of claim 9, wherein the housing includes an opening aligned with the eccentric screw, the opening capable of receiving a screwdriver to adjust the orientation of the eccentric screw.

11. The apparatus of claim 7, further comprising an eccentric screw positioned to restrict motion of the arm assembly at a corresponding arm position that corresponds to the first position of the blade assembly.

12. The apparatus of claim 1, further comprising a first sensor configured to detect presence of the blade assembly at the first position and cause a controller to deactivate the motor responsive to receiving a first signal from the first sensor indicative of the presence of the blade assembly at the first position.

13. The apparatus of claim 12, further comprising a second sensor configured to detect the presence of the blade assembly at the second position and cause the controller to deactivate the motor responsive to receiving a second signal from the second sensor indicative of the presence of the blade assembly at the second position, wherein the controller is further configured to activate the motor to cause the blade assembly to move from the second position to the first position in response to at least one of deactivating a motor actuator or an expiration of a waiting period.

14. A method for preparing slides with samples for acquisition of measurement data by at least one analytical instrument, comprising:
receiving one or more slides at one or more structures;
actuating a motor mechanically coupled to a blade assembly and disposed within a housing, the blade assembly including one or more blades configured to prepare for measurement one or more samples on one or more slides; and
causing, responsive to actuating the motor, the blade assembly to move from a first position to a second position and return from the second position to the first position, each blade of the one or more blades is configured to prepare for measurement a corresponding sample of the one or more samples placed on a corresponding slide of the one or more slides responsive to the blade assembly moving from the second position to the first position.

15. The method of claim 14, comprising causing the blade assembly to pause at the second position for a waiting period before returning from the second position to the first position.

16. The method of claim 15, comprising determining the waiting period according to at least one of:
an input parameter specifying the waiting period; or
an amount of time during which a motor actuator of the motor is actuated.

17. The method of claim 14, comprising:
detecting, by a first sensor, presence of the blade assembly at the first position; and
deactivating, by a controller, the motor responsive to receiving a first signal from the first sensor indicative of the presence of the blade assembly at the first position.

18. The method of claim 17, comprising:
detecting, by a second sensor, the presence of the blade assembly at the second position; and
deactivating, by the controller, the motor responsive to receiving a second signal from the second sensor indicative of the presence of the blade assembly at the second position.

19. The method of claim 14, wherein the motor is mechanically coupled to the blade assembly via an arm assembly, the method comprising:
restricting, by an eccentric screw, motion of the arm assembly at an arm position that corresponds to the second position of the blade assembly, the eccentric screw comprising a first screw including a screw head and a shaft arranged at an offset relative to an axis of the screw head, the screw head defining an opening sized to receive a second screw.

20. The method of claim 19, comprising adjusting an orientation of the eccentric screw to calibrate the second position.
